(19) United States
(12) Patent Application Publication
(10) Pub. No.: US 2024/0146060 A1
(43) Pub. Date: May 2, 2024

(54) METHODS AND SYSTEMS FOR CONTROLLING ELECTRIC VEHICLE CHARGING BASED ON POWER DISTRIBUTION SYSTEM INFORMATION

(71) Applicant: BluWave Inc., Ottawa (CA)

(72) Inventors: Alexander LINCHIEH, Ottawa (CA); Amir LOTFI, Ottawa (CA); Devashish PAUL, Ottawa (CA); Thomas TRIPLET, Ottawa (CA)

(21) Appl. No.: 18/494,927

(22) Filed: Oct. 26, 2023

Related U.S. Application Data
(60) Provisional application No. 63/419,537, filed on Oct. 26, 2022.

(51) Int. Cl. H02J 3/12; B60L 53/63; H02J 3/00; H02J 7/00

(52) U.S. Cl. CPC H02J 3/12; B60L 53/63; H02J 3/003; H02J 7/00712

(57) ABSTRACT

Methods and systems are provided for controlling the charging of electric vehicles (EVs) and other assets based on power flow information of a power grid. The strategic control of charging of the assets, by way of generated charging control information, contributes to an effort to respect technical constraints of the power system, thereby minimizing violations of the technical constraints, and thus minimizing damage to the power grid infrastructure. New power flow information for a subsequent time period may then be generated based on the at least part of the charging control information, and this new power flow information may then in turn be used to generate new charging control information for the subsequent time period. In addition, a method contribute to the generation of a solution to an optimal power flow (OPF) problem in the power grid based on strategic controlling of the charging of a plurality of assets in the power system.

### CROSS REFERENCE TO RELATED APPLICATIONS

The present application claims priority to or benefit from U.S. Provisional Patent Application No. 63/419,537, filed on Oct. 26, 2022, which is incorporated herein by reference.

### FIELD

The present disclosure relates generally to power distribution, and more particularly to controlling charging of assets, for example electric vehicles (EVs), in power distribution systems.

### BACKGROUND

Power systems are undergoing a major transition, partly to meet worldwide ambitions to reduce greenhouse gas emissions. Some manifestations thereof are the increased penetration of renewable power generation, for example wind and solar, the proliferation of energy storage systems (ESS) including distributed energy storage systems (DESS), and the adoption of EVs as an alternative for internal combustion engine vehicles.

The charging of proliferating EVs adds a very significant load to power systems, in particular during peak hours, which can require upgrades in power transmission and/or distribution infrastructure, for example lines and transformers in residential areas, which can be cost prohibitive.

In addition, power system infrastructure may be damaged when overloaded.

The increasing market penetration of EVs will only increase the overall load and its adversarial effects on the power system.

Some techniques have been proposed. However, improvements are desired.

The above information is presented as background information only to assist with an understanding of the present disclosure. No assertion or admission is made as to whether any of the above, or anything else in the present disclosure, unless explicitly stated, might be applicable as prior art with regard to the present disclosure.

### BRIEF DESCRIPTION OF THE DRAWINGS

Example embodiments of the present disclosure will now be described with reference to the attached Figures.

FIG. 1 shows an example power system.

FIG. 2A is a graph illustrating an example of overloading at a transformer.

FIG. 2B is a graph illustrating an example of voltage violations at a transformer.

FIGS. 3A-3F are graphs illustrating two example scenarios in which the number of voltage and overloading violations increases to unacceptable levels as the market share of EVs increases.

FIGS. 4A-C are graphs showing how owner behaviour and decisions may affect arrival time, journey, and/or associated energy demand.

FIG. 5 is a diagram illustrating an example control system.

FIG. 6 is a diagram illustrating another example control system.

FIG. 7 is a graph showing loading versus hours in an example scenario.

FIG. 8 is a graph illustrating an example of a function or operation at demand-response recommender.

FIGS. 9A-B are examples of EV charging control or scheduling.

FIG. 10 is a process flow diagram of an example method.

FIG. 11 is a block diagram of an example computerized device or system.

### DETAILED DESCRIPTION

In an aspect, the present disclosure is generally directed to improvements in computer-based technologies relating to strategic controlling and managing the charging of assets, for example EVs, in a power system. In an aspect, the present disclosure relates to controlling the charging of assets, such as EVs, in a power system such that the charging of the assets contributes to an effort to respect technical constraints of the power system. In an aspect, the controlling may include performing one or more optimizations in relation to one or more objectives. In an aspect, the present disclosure provides methods and systems that generate a solution, or contribute to the generation of a solution, to an optimal power flow (OPF) problem in a power system based on controlling of the charging of a plurality of assets in the power system. In an embodiment, determined charging related information, for example current and/or future charging schedule information, may be provided to an OPF solver for use in solving an OPF problem for a subsequent time period. These improvements may reduce or eliminate damage caused to parts of the physical power system that would otherwise have been caused by surges in power demand, which may in part be contributed to by the charging of the assets.

As the number of EVs increases, the charging of EVs adds a significant load to power systems, particularly during peak hours, thereby possibly requiring lines and transformers in residential areas to be upgraded in order to be able to handle the increased load, which is costly if not cost prohibitive.

In addition, power system infrastructure may be damaged when overloaded. For instance, insulation degradation is a common problem with transformers, particularly aging transformers. Overloading causes overheating and, eventually, thermal degradation and insulation cracks. The transformer typically deteriorates faster if the transformer is frequently overloaded, or the voltage exceeds the operational limits, for example because there is no direct control over the consumption of the downstream customers. Customer generally refers to an end user or consumer of electricity. Overloading generally refers to a situation when an electrical device or component is operated beyond a safety threshold, for example by carrying more electrical current than a maximum rated capacity of the device or component. Furthermore, an occurrence in which an electrical device or component is operated above a predefined maximum threshold may be referred to as a violation. Affected transformers may be any transformers in a power distribution system, including distribution transformers (such as those that provide a final voltage step-down to a voltage supplied to customers), and transformers at distribution substations.

According to an aspect, the present disclosure is directed to a system, comprising a computer-readable storage medium having executable instructions for providing charging control to a plurality of electric controllable assets which include at least some electric vehicles (EVs); and one or more computer processors configured to execute the instructions to determine, by a power flow analyzer, power flow information of a power grid, the power grid for providing power to the controllable assets for charging, the power flow information including technical constraint information relating to the power grid; generate, by a charging controller, charging control information for providing charging control to the controllable assets based on the power flow information; provide the charging control information to at least some of the controllable assets; provide at least part of the charging control information to the power flow analyzer; and determine, by the power flow analyzer, new power flow information of the power grid for a subsequent time period based on the at least part of the charging control information.

In an embodiment, the one or more computer processors are further configured to execute the instructions to generate, by the charging controller, new charging control information associated with the subsequent time period based on the new power flow information.

In an embodiment, the determining the power flow information of the power grid by the power flow analyzer is based on topology information and electrical measurement information of the power grid.

In an embodiment, the charging control information includes EV charging scheduling information.

In an embodiment, the one or more computer processors are further configured to execute the instructions to generate, by a demand-response recommender, recommended load curtailment information, the recommended load curtailment information including details for load curtailment in the power grid, wherein at least one of: the recommended load curtailment information is provided to the charging controller, and wherein the generating charging control information is based on the recommended load curtailment information; and wherein the recommended load curtailment information is provided an operator of the power grid.

In an embodiment, the recommended load curtailment information is provided to the power flow analyzer, and wherein the determining new power flow information of the power grid for the subsequent time period is based on the recommended load curtailment information; and wherein the generating, by the charging controller, of the new charging control information associated with the subsequent time period is based on the new power flow information.

In an embodiment, the generating charging control information is further based on predicted load information of the power grid, wherein the predicted load information includes a predicted electric load in a section of the power grid in a future time period.

In an embodiment, the technical constraint information of the power grid comprises operational limit information of one or more distribution transformers in the power grid.

In an embodiment, the generating charging control information is based at least in part on an optimization for minimizing violations of the technical constraint information in the power grid.

In an embodiment, the at least part of the charging control information provided to the power flow analyzer includes information indicating how controllable assets responded to charging control actions in the charging control information.

According to an aspect, the present disclosure is directed to a method comprising at one or more electronic devices each having one or more processors and computer-readable memory, for providing charging control to a plurality of electric controllable assets which include at least some electric vehicles (EVs): determining, by a power flow analyzer, power flow information of a power grid, the power grid for providing power to the controllable assets for charging, the power flow information including technical constraint information relating to the power grid; generating, by a charging controller, charging control information for providing charging control to the controllable assets based on the power flow information; providing the charging control information to at least some of the controllable assets; providing at least part of the charging control information to the power flow analyzer; and determining, by the power flow analyzer, new power flow information of the power grid for a subsequent time period based on the at least part of the charging control information.

In an embodiment, a method further comprises generating, by the charging controller, new charging control information associated with the subsequent time period based on the new power flow information.

In an embodiment, the determining the power flow information of the power grid by the power flow analyzer is based on topology information and electrical measurement information of the power grid.

In an embodiment, the charging control information includes EV charging scheduling information.

In an embodiment, a method further comprises generating, by a demand-response recommender, recommended load curtailment information, the recommended load curtailment information including details for load curtailment in the power grid, wherein at least one of: the recommended load curtailment information is provided to the charging controller, and wherein the generating charging control information is based on the recommended load curtailment information; and wherein the recommended load curtailment information is provided an operator of the power grid.

In an embodiment, the recommended load curtailment information is provided to the power flow analyzer, and wherein the determining new power flow information of the power grid for the subsequent time period is based on the recommended load curtailment information; and wherein the generating, by the charging controller, of the new charging control information associated with the subsequent time period is based on the new power flow information.

In an embodiment, the generating charging control information is further based on predicted load information of the power grid, wherein the predicted load information includes a predicted electric load in a section of the power grid in a future time period.

In an embodiment, the technical constraint information of the power grid comprises operational limit information of one or more distribution transformers in the power grid.

In an embodiment, the generating charging control information is based at least in part on an optimization for minimizing violations of the technical constraint information in the power grid.

In an embodiment, the at least part of the charging control information provided to the power flow analyzer includes information indicating how controllable assets responded to charging control actions in the charging control information.

According to an aspect, the present disclosure is directed to a non-transitory computer-readable medium comprising computer-readable instructions stored on the computer-readable medium, the instructions for providing charging control to a plurality of electric controllable assets which include at least some electric vehicles (EVs), the computer-readable instructions executable by at least one processor to cause the performance of operations comprising: determining, by a power flow analyzer, power flow information of a power grid, the power grid for providing power to the controllable assets for charging, the power flow information including technical constraint information relating to the power grid; generating, by a charging controller, charging control information for providing charging control to the controllable assets based on the power flow information; providing the charging control information to at least some of the controllable assets; providing at least part of the charging control information to the power flow analyzer; and determining, by the power flow analyzer, new power flow information of the power grid for a subsequent time period based on the at least part of the charging control information.

In an embodiment, the instructions further cause operations comprising generating, by the charging controller, new charging control information associated with the subsequent time period based on the new power flow information.

In an embodiment, the determining the power flow information of the power grid by the power flow analyzer is based on topology information and electrical measurement information of the power grid.

In an embodiment, the charging control information includes EV charging scheduling information.

In an embodiment, the instructions further cause operations comprising generating, by a demand-response recommender, recommended load curtailment information, the recommended load curtailment information including details for load curtailment in the power grid, wherein at least one of: the recommended load curtailment information is provided to the charging controller, and wherein the generating charging control information is based on the recommended load curtailment information; and wherein the recommended load curtailment information is provided an operator of the power grid.

In an embodiment, the recommended load curtailment information is provided to the power flow analyzer, and wherein the determining new power flow information of the power grid for the subsequent time period is based on the recommended load curtailment information; and wherein the generating, by the charging controller, of the new charging control information associated with the subsequent time period is based on the new power flow information.

In an embodiment, the generating charging control information is further based on predicted load information of the power grid, wherein the predicted load information includes a predicted electric load in a section of the power grid in a future time period.

In an embodiment, the technical constraint information of the power grid comprises operational limit information of one or more distribution transformers in the power grid.

In an embodiment, the generating charging control information is based at least in part on an optimization for minimizing violations of the technical constraint information in the power grid.

In an embodiment, the at least part of the charging control information provided to the power flow analyzer includes information indicating how controllable assets responded to charging control actions in the charging control information.

The present disclosure often refers only to EVs for simplicity, for example to the charging of EVs, and the controlling of charging of EVs, and so on. However, the references to EVs are intended to refer to and include any suitable assets, including BESSs, and so on.

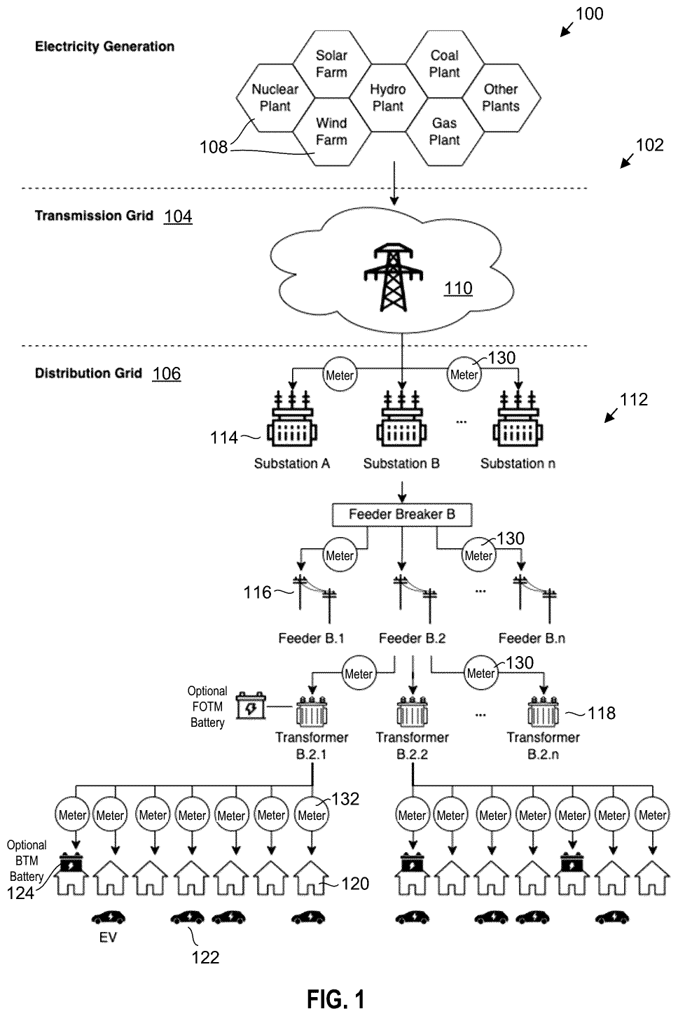

FIG. 1 shows an example power system 100. A power system generally refers to any system that involves the transmission and/or distribution of power, including electrical power. A power system may include a power grid 102, which is generally a network for transmission and distribution from power produces to end customers. In addition, a power system may refer to only part of a power grid. However, in general, the terms power system and power grid are used interchangeably herein. Furthermore, a power grid generally refers to any power network or system, and is thus not limited to a conventional power grid. A power grid may be subdivided into several sub grids, for example a power transmission grid 104 and a power distribution grid 106. A power grid generally comprises one or more power generating plants 108, power transmission infrastructure 110 to carry power long distances, and power distribution infrastructure 112 to deliver power to end customers. Power generating plants 108 may include any types of power generation, such as fossil fuel such as coal or gas, nuclear, and renewables such as solar, wind, and so on. Power distribution infrastructure 112 may include one or more substations 114, for example for stepping down the voltage from the transmission infrastructure to a lower voltage for the distribution infrastructure. Power distribution infrastructure 112 may include one or more feeders 116, which are electrical conductors, for example for delivering power from substations 114 to locations further downstream in the distribution infrastructure 112, such as distribution transformers 118. Distribution transformers 118 may further step down the voltage from the feeder lines 116 to a lower voltage, for example for delivery to end customers 120. EVs 122 may be associated with the customers 120. Customers 120 may be associated with any type(s) of power customer, for example a home or other building or dwelling, a charging station, a charge point, an EV, an ESS such as a batter energy storage system (BESS) 124, and so on. A tree like structure of the distribution grid 106 may be thought of as having multiple different branches, for example from a substation to various feeders, or from a feeder to various transformers, and so on.

Power system 100 may have electrical meters, for example distribution meters 130 and/or customer meters 132, at various locations in the system 100. Meters may be used to measure any types of electrical parameters, such as current, voltage, power, and so on.

An example of power system infrastructure being overloaded is now described. Referring to FIG. 1, assume that it around 5 pm on a work day during the summer when many homes are running the electric air conditioners of their homes, and several people in a neighborhood arrive back at home (for example from work) in their EVs. In this example, the people in the neighborhood all live at homes that are serviced by transformer B.2.1 in FIG. 1. Upon arrival at home, they connect their EVs 122 to charge points at their homes 120, and the EVs begin charging immediately. The people also turn on various electrical devices in their homes, such as stoves, ovens, and washing machines. The customer demand during this on-peak time is very high.

As the people who live in homes serviced by transformer B.2.1 begin to own or use more EVs, the load on the subset of the power grid 106 infrastructure that services these people will increase. At a certain point, the number of EVs at these homes will likely reach a point at which the demand (load) will at times exceed the operational limits of electrical components in the subset of the power grid 106 infrastructure that services these people, which includes transformer B.2.1. The exceeding of the operational limits of the component(s) will constitute an overloading of this subset of the power grid 106, thereby potentially causing physical damage to at least some of the electrical components in the power grid 106, possibly including transformer B.2.1.

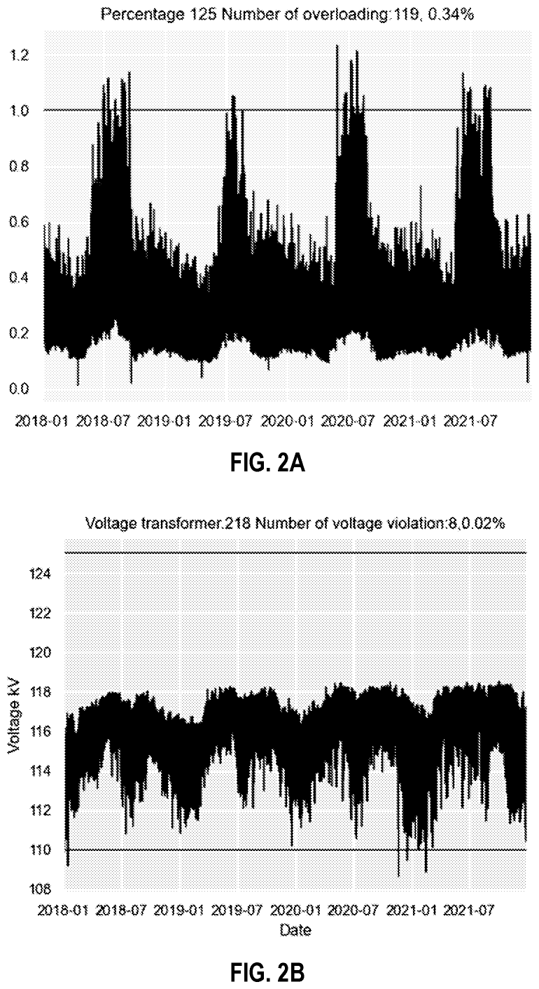

FIG. 2A is a graph illustrating an example of overloading and FIG. 2B is a graph illustrating an example of voltage violations for a transformer. These figures show how much power flows through the transformer and sometimes exceeds a maximum allowed power. Moreover, the transformers can undergo voltage violations, which often cause exceeding the minimum and/or maximum allowed voltages due to power flow fluctuations. Overloading and voltage violations in transformers will often result in a shorter lifespan of the transformers, high maintenance and replacement costs and power outages.

In addition, the increasing market penetration of EVs will likely increase the overall load and its adversarial effects on the power system.

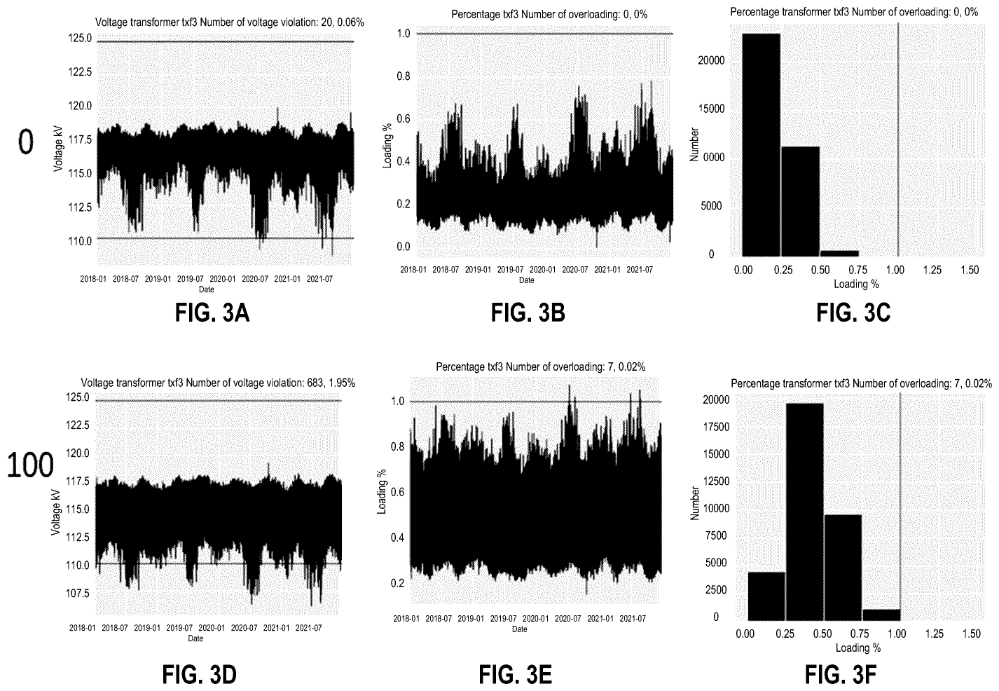

FIGS. 3A-3F are graphs illustrating two example scenarios in which the number of voltage and overloading violations increases to unacceptable levels as the market share of EVs increases. In the first scenario, represented by the graphs of FIGS. 3A-C, there are no EVs (0% EV penetration). In the second scenario, represented by the graphs of FIGS. 3D-F, all vehicles are EVs (100% EV penetration). The graphs in FIGS. 3A and 3D show voltage, the graphs in FIGS. 3B and 3E show loading as a percentage, and the graphs in FIGS. 3C and 3F show the number of transformers versus loading.

To address some of these issues, solutions have been proposed to help reduce the load during peak hours. However, EV charging demands are often particularly difficult to coordinate among controllable loads due to constraints on the timing and duration of asset availability. For example, an energy requirement of an EV must typically be met during its journey. On the other hand, arrival time, journey, and/or associated energy demand of an EV are often influenced by their owners' behavioral patterns and/or fleet owner routing decisions.

Assets in the system may include any suitable assets, including controllable assets. In various embodiments, the controllable assets include one or more vehicles, which may be vehicles in a vehicle fleet system. Vehicles may include EVs. EVs may be any type or types of vehicles. They may include trucks, cars, buses, motorcycles, snowmobiles, bikes, scooters, trains, boats, ships, other watercraft, airplanes, helicopters, other aircraft, and spacecraft. The vehicles may be manned and/or unmanned, manually operated and/or autonomous vehicles. Further, assets may include assets in a power system, such as BESS or other types of ESSs, and so on.

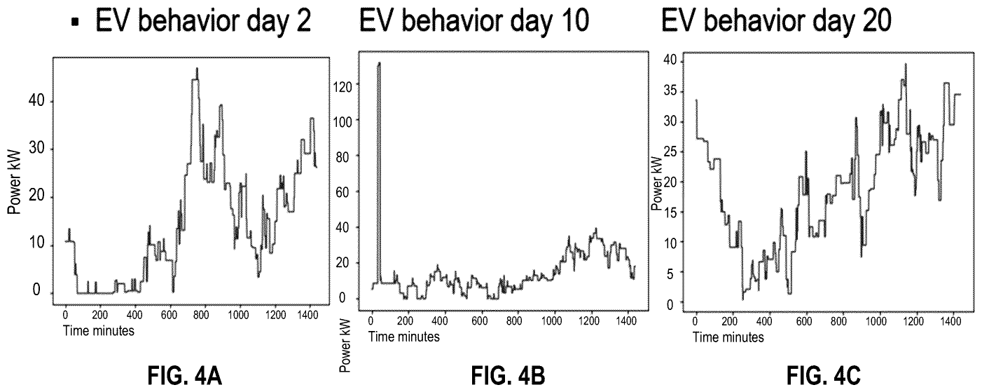

FIGS. 4A-C are graphs showing how owner behaviour and decisions may affect arrival time, journey, and/or associated energy demand. The graphs show some example owner behaviour of a total of 57 EVs on three days, namely day 2 (FIG. 4A), day 10 (FIG. 4B), and day 20 (FIG. 4C) in which the y-axis is consumed power of 57 EVs and the x-axis is the minute of the day.

The management and charging of fleets of multiple EVs may compound the above difficulties. A fleet management system may attempt to optimize and coordinate the charging of all EVs in the fleet to maximize the overall efficiency of the fleet, while accounting for the heterogeneity of individual behavioral and driving patterns, as well as the significant load on the power system and the physical and electrical characteristics of the transformers. The management of EV charging may consider users profiles and may have EVs charged at preferred departure times of the users.

Time-Of-Use pricing, where energy prices change over time, for example throughout the day or based on the date, may be used in an attempt to optimize charging of EVs. Also, basic timers may be used to schedule the charging of the EV overnight during off-peak hours.

However, the applicability of these approaches is often limited. Such approaches are often unable to dynamically and/or globally optimize the charging of EVs which means finding the absolute optimum charging schedule.

According to an aspect of the present disclosure, an effort to reduce or eliminate the instances of overloading may be contributed to by controlling the charging of EVs and any other suitable controllable assets in the system in an intelligent and strategic manner. As a mere example, in FIG. 1, there are 4 EVs 122 shown at homes 120 that are serviced by transformer B.2.1.

A computer based charging controller (not shown in FIG. 1) according to the present disclosure may provide control and management of the charging of the 4 EVs in a manner that tries to reduce the chance of an overload. The charging controller may receive information about the power grid, as well as from other sources, that may be useful in determining how to efficiently or optimally charge EVs and other assets. Such received information may include technical constraint information relating to the power grid, which may be used by the charging controller to charge EVs and other assets, for example to attempt to reduce the chance of an overload to the grid. The information may be received at the charging controller from a power flow analyzer (not shown in FIG. 1) in the system. An attempt to reduce the chance of an overload may be done by attempting to ensure that, based on the information known to the charging controller about loading in the power grid, which may include predicted information, that the charging controller does not command EVs to charge when such charging would knowingly likely violate technical constraints of the power grid, likely causing an overload in the grid. In this manner, the charging controller uses information known about the power grid, which may include current loading, historical loading, predicted loading, historical, current, and predicted available capacity information of the grid (e.g. how much of the total capacity of a component is being used and how much is available for use, etc.), known electrical capacities of various components of the grid (e.g. maximum operational limits of the components), and so on. Technical constraint information of the power grid may be based in part on known electrical capacities of various components of the grid.

The power flow analyzer may have or receive information relating to the power grid 106, 102, for example historical, current, and/or predicted loading information, which may include the loading on various parts of the power grid and its components, for example transformers B.2.1, B.2.2, B.2.n, feeder infrastructure B.1, B.2, B.n, and so on. The information may include currents, voltages, powers, phases, angles, and so on. Historical and current loading information may be obtained using various meters 130, 132 throughout the power grid 106. Other information received at the charging controller may include information about the topology of the power grid 106, information about other assets in the power grid 106, 102 such as ESSs, renewable generation, information relating to power generation and transmission, and so on. The power flow analyzer may be able to identify instances of overloading in the power grid, including at specific regions and components in the power grid, for example from information obtained from various meters and other sources.

Thus, the charging controller may have information relating to the power grid 106, 102 that it may use when managing the charging of the 4 EVs at the homes 120 that are serviced by transformer B.2.1. For example, charging controller may generate charging control information that includes an instruction for one of the EVs to begin charging immediately upon being connected to a charge point, for example if the EV owner has indicated in some form that they will be departing again very shortly and thus need immediate charging of their EV. In addition, the charging controller may schedule the charging of the other 3 EVs at later off-peak times during the evening or night when overall load on the grid is lower. For example, one of the EVs may be scheduled to charge at 9 pm while the other two EVs may be scheduled to charge at 1 am. In this way, the charging controller attempts to reduce the chances of overloading of the subset of the power grid 106 infrastructure, including transformer B.2.1., by managing the timing or scheduling of charging of EVs.

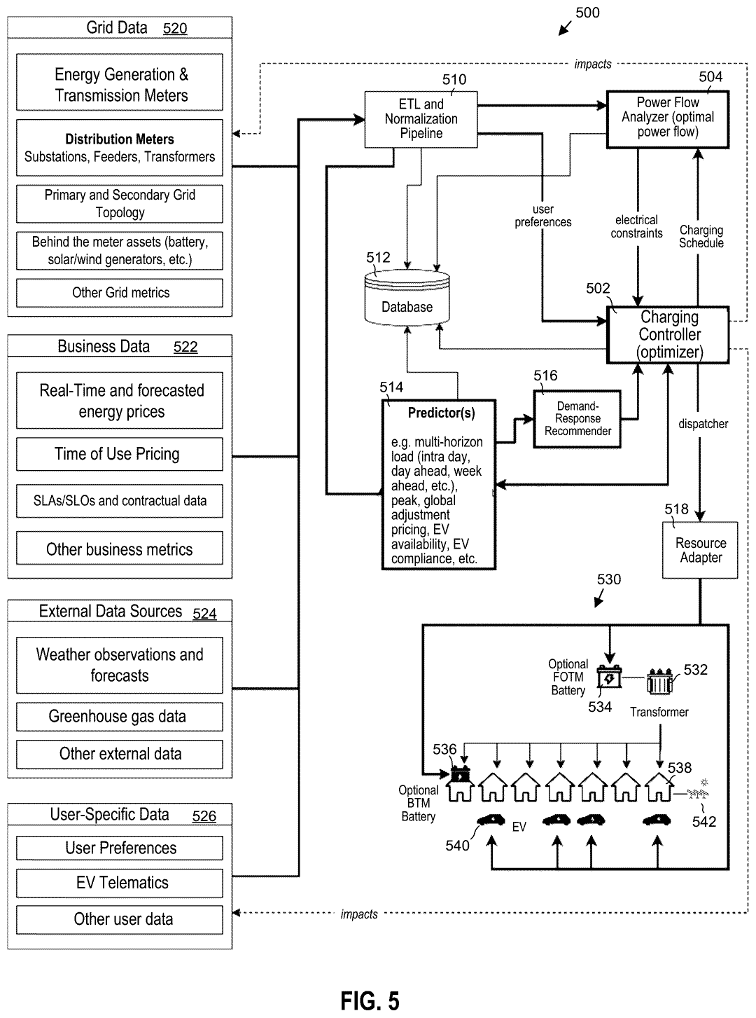

In addition, the charging controller may provide at least some of the charging control information, for example EV charging schedule information, BESS charging/discharging schedule information, and possibly information about the charging rates (e.g. current) to be used, to the power flow analyzer. The providing of this information to power flow analyzer is represented by a “charging schedule” signal in FIG. 5, nothing the term “charging schedule” is not meant to be limiting but instead includes any information not limited to charging control information. The information may include, for example, indicating how controllable assets responded to charging control actions in the charging control information, for example if an asset actually partially or fully implemented charging related actions provided by the charging controller 502, and/or the impact on the grid (e.g. load etc.) of the actual actions of the asset. This information may provide indications of how current and future charging of EVs will affect the loading other parameters of the power grid. This information may be used by the power flow analyzer, for example to determine more accurate power flow information, for example for a subsequent time period. In this regard, the power flow analyzer may determine new power flow information of the power grid for a subsequent time period based on the at least part of the charging control information. The charging controller may, in turn, generate new charging control information associated with the subsequent time period based on the new power flow information. In this regard, the charging controller 502 and power flow analyzer may cooperate in an iterative manner.

The above example is a merely a simplified example to illustrate concepts of charging control of EVs to contribute to the reduction of violations and overloading in the power grid. In some embodiments, the charging controlling may involve much larger portions of a power grid and many more EVs and other assets, such that there are EVs associated with many different subsets or branches in the power grid, and so on, and the charging controller receives power flow information relating to these branches of the power grid and generates charging controlling information that takes into account these EVs associated with the many different subsets or branches in the power grid.

In some embodiments, the charging controller may perform optimizations when generating charging control information for controlling EVs.

Optimal power flow (OPF) generally refers to an optimization problem in power systems that aims to optimize some aspect of the power system, for example the dispatch of power generation, while observing technical and/or operational constraints of the power system. A primary task of electrical grid operators is daily planning to dispatch power generation in order to satisfy demand at a minimum cost while respecting constraints of the system, such as technical and operational constraints. This task usually involves solving an optimization problem in the form of an OPF problem. The problem is often complex due at least in part to the high number of components in the system and the way in which the components interact with each other. There is generally a goal of maintaining a balance between the amount of power that is generated and the amount of power that is consumed in the system. OPF may aim to determine values for the system variables that optimizes one or more of the functionalities of the system. An OPF problem may model the generation and distribution of power through a power network at a specific point in time. The power network may be represented by a graph comprising nodes that generate and/or consume power and arcs or lines that transport the power. The arcs are sometimes called lines, and the nodes are sometimes called buses. For example, OPF may determine the dispatch of power generation units to satisfy an electricity demand at a minimum cost while adhering to technical and/or operational constraints.

FIG. 5 is an example control system 500 according to the present disclosure. Control system 500 may generally comprise a charging controller 502 and a power flow analyzer 504. System 500 may include or be associated with a power grid or system 530, which may be a portion of a larger power grid. System 500 may generally provide for the control of controllable assets in the system, for example EVs 540, front of the meter BESS 534, and/or behind the meter BESS 536, based on information relating to the power grid 530.

In addition, system may comprise an ETL pipeline 510 (e.g. data processor), one or more databases 512, one or more predictors 514, a demand-response recommender 516, and a resource adapter 518. Moreover, system 500 may acquire data and other information from any number of various sources, both internal and/or external to system 500. For example, system 500 may receive information such as grid data 520, business data 522, external data sources 524, and user-specific data 526, and so on.

In this simplified example, power grid 530 comprises transformer 532, multiple homes or buildings 538, several EVs 540, and optional BESSs 534, 536. The reference to homes is merely for simplicity and is meant to generally refer to any customer or consumer of power.

In addition, there may be one or more sources of power generation 542 in the power grid 530, such as renewable power sources at or connected to one or more of the homes 538. Such power may be temporarily stored at the home in an ESS such as a BESS 536. For example, any power generated at a home from such a source 542, or power stored in a BESS 536 at or associated with a home, may be taken into account by charging controller 502 when generating the charging control information. Any power generated at or stored at a home may be used for part or full charging of an EV, and thus such power need not come from the power grid 530, and thus may not have any impact on the load of the power grid 530 or on any technical constraints on the grid. In addition, energy stored elsewhere in the power grid 530, such as energy in a front of the meter BESS 534, may be used in place of or to supplement power from other electricity generation sources such as power generating plants 108 (FIG. 1). Although, the energy from such BESS 534 may need to be transmitted to the homes 538 through part of the power grid 536, so this power will likely have an impact on the load of the power grid 530 and thus will likely be subject to technical constraints on the power grid 530.

Computer based charging controller 502 may provide control and management of assets 540, 534, 536, for example in a manner that attempts to reduce the chance of an overload in power grid 530. Charging controller 502 may receive information relating to the power grid 530, for example from power flow analyzer 504, as well as from other sources, that may be useful in determining how to efficiently or optimally charge EVs 540 and other assets. Such received information may include technical constraint information relating to the power grid 530, which may be used by the charging controller 502 to charge EVs, for example to attempt to reduce the chance of an overload to the power grid 530.

Charging controller 502 may provide the charging control information to the EVs and other assets, which is represented in FIG. 5 as a “dispatcher” signal from charging controller 502 the EVs 540 in the power grid 530, possibly via an optional resource adapter 518.

Power flow analyzer 504 may generally receive various types of information and may generate power flow information that may be provided to and used by charging controller 502. In FIG. 5, information provided by power flow analyzer 504 to charging controller 502 is represented by a signal labeled “electrical constraints”, although this label is not meant to be limiting. The power flow information may include information that may be used by the charging controller 502 to control the charging of EVs and other assets in a manner that attempts to minimize the chance of an overload in the power grid 530. The power flow information may include any information relating to the power grid such as voltage, current, input power, output power, and their directions. Power flow information may include technical constraint information, which may be technical constraint information of the power grid 530, which may be based in part on known electrical capacities of various components of the grid, for example transformer 532, and so on. Technical constraint information could include information indicating to the charging controller that transformer 532 is currently at 80% of its operational limit, or is predicted to be at 80% of its operational limit in an upcoming time period, and thus transformer 532 only has 20% capacity remaining, for example for any additional charging of EVs or other assets. Charging controller 502 may thus attempt to control the charging of EVs and other assets so that the charging does not exceed the available 20% capacity of the transformer 532.

The power flow information may be generated by the power flow analyzer 504 based on any suitable information, for example information acquired from or otherwise relating to the power grid, for example any of grid data 520, and so on. For example, power flow information of the power grid may be determined by the power flow analyzer based at least in part on topology information and/or electrical measurement information of the power grid.

In addition, system 500 may comprise an extract, transform, and load (ETL) and normalization pipeline 510, or any other suitable data processor, which may be configured to obtain data and other information from multiple sources, and transform and store the data, for example in a database 512. In addition, pipeline 510 may perform data normalization on the data, for example to organize data so that it seems consistent across records and fields. Furthermore, pipeline 510 may perform preprocessing on the data, which may include data cleaning, data conditioning, data warehousing or other operations on received data. Pipeline 510 may transform data into a format more suitable for machine learning techniques. Additionally, Pipeline 510 may perform other tasks such as identifying and removing outliers from the data, filling-in or removing gaps in any of data sources, or applying standardization or normalization or transformation techniques on the data, for example to make training or inference processes more accurate. The processed data and other information of pipeline 500 may be stored in database 512, provided to charging controller 502, provided to power flow analyzer 504, and/or provided to one or more predictors 514.

In addition, system 500 may comprise one or more predictors for predicting various types of information that may be used by system 500. Example types of information are electrical load in the power grid 530, which may include loads at various points or regions or branches or components in the grid 530, where predicted load information may be for any future time or time period such as for one or more time periods of any length such as 1 hour blocks, 30 minute blocks, 15 minute blocks, and so on. The load information may be predicted for future time periods or blocks in the same day, in a next day, in a next week, or in any other suitable future time period. Another example of information that may be predicted by a predictor may be peak load information, which may refer to predicting upcoming load peaks in the grid (peak demand generally refers to a highest power demand in a power system or grid during a specified time period), for example in the entire grid or in specific points, regions, branches, or components of the grid. Another example of information that may be predicted is electricity market price information, which may refer to a cost of energy from the power grid (e.g. $/kWh), which may typically fluctuate over time. Market price may include several components, such as an hourly energy price and a global adjustment (GA). An hourly energy price may be an average of market clearing prices (MCP) set in each hour or other time period. Global adjustment (GA) may be another cost component of an electricity market price, and may cover costs such as those for constructing new electrical infrastructure, maintaining existing generation sources, and so on. Thus, future hourly energy price and/or global adjustment may be predicted. Another example of information that may be predicted is EV availability, which may refer to when EVs are predicted to be available for charging, for example when an EV may be connected to one or more specific charge points in the power grid 530. This may be used to manage and schedule the charging of multiple EVs. Another example of information that may be predicted is EV owner compliance with EV charging instructions, which may refer to the probability that an EV owner will follow charging schedules and/or instructions from the charging controller 502, for example based on output of its optimizer. EV owner compliance may be injected back to the charging controller as a feedback loop to further refine the recommendations from the charging controller.

Another example of information that may be predicted is future power generation or availability in the power grid 530, for example from power generating plants 108 (FIG. 1) and/or from any other sources, such as renewable generators within the grid 530 or at homes 538, such as solar generator 542, and so on. Predicted power generation may include total power generation available to the grid, or predicted power generation from various different sources or generation types, for example coal, hydro, solar, wind, or renewable versus non renewable, and so on. Another example of information that may be predicted is information indicating a time when it may be best to charge an EV to use power generated with low or lowest emissions (e.g. greenhouse gas emissions).

Another example of information that may be predicted is user profile information, which may include or relate to behaviour of EVs (or their users) in the future based, for example based on their behaviour in the past, for example which include EVs charging and discharging behaviour (e.g. times, dates, durations, locations, and so on), EVs driving profile, past departure and arrival depending on the days of the week or weather conditions, SoC at departures from a charge point, SoC at arrivals back to a charge point, and so on. Another example of information that may be predicted is EV or other asset charging demand, overall power demand in the power grid 530, and so on.

Another example of information that may be predicted is future ESS storage levels (e.g. SoC), for example of in front of meter BESSs and/or behind the meter BESSs, predicted weather information, and predicted vehicle traffic information. Predicted weather information may provide information or insights relating to future EV charging demand, for example if predicted weather is poor, then predicted EV charging demand may be lower during and after the poor weather since the number of EVs on the road during the poor weather may be lower, and so on. Predicted traffic information may provide information or insights relating to future EV charging demand, for example if traffic is predicted to be heavy, then predicted EV charging demand may be higher after the heavy traffic since it may take many EVs longer than usual to complete their journeys, thus potentially using more energy in their EV batteries.

In addition, system 500 may acquire information from any number of various sources, and system 500 may receive information such as grid data 520, business data 522, external data sources 524, and user-specific data 526, and so on.

Grid data 520 may include information relating to energy generation, such as historical, current and future levels of energy generation, and energy generation levels may include generation at any sources such as power generating plants 108 (FIG. 1) and/or from any other sources, such as renewable generators within or connected to the power grid. In addition, grid data 520 may include readings or other information from meters, such as transmission meters and distribution meters, within a power grid such as voltages, currents, power levels, and so on. In addition, grid data 520 may include information relating to components in the power grid, such as grid topologies, including primary and secondary topologies, meter readings at substations, feeders, transformers, BESSs, and technical specifications, such as types, technical specifications and constraints, operational limits, and so on, of components such as transformers, substations, BESSs, and so on.

Business data 522 may include information relating to historical, current, real-time, and future predicted energy price information, which may be or include energy market price information, time of use pricing information, service level agreement (SLA) information between a service provider, such as a power system operator, and a customer, where SLA information may include service level objective (SLO) information, other business or contractual or related information or metrics.

Other external data 524 may include information relating to historical, current, real-time, and future predicted weather information, greenhouse gas emission information, or any other suitable information. Weather information may include, for example data relating to sunlight, irradiance, cloud coverage, precipitation, storms or other weather events, wind speed, temperature, or humidity, and so on. Weather may impact renewable generation, for example since various sources of renewable energy are intermittent and not continuous. In addition, weather may impact EV behaviour, such as if and when EVs are on the road, the amount of time it takes for their journeys, and so on, which in turn may affect EV charging demand.

User-specific data 526 may include information relating to EV user preferences, such as EV user behaviours and so on, EV telematics, and any other suitable type of user data. EV user preferences or behaviours may include patterns of charging times, locations, charging lengths, departure and arrival times, SoC information at departures and arrivals, and so on. Generally, telematics data may include any information or data relating to a vehicle, including but not limited to SoC of a battery of an EV, energy level of the battery, vehicle location, route, number of stops, tire pressure, idling time, speed, rate of acceleration (for example gentle, medium, or high), rate of braking, fuel consumption, vehicle faults, vehicle diagnostics, and so on.

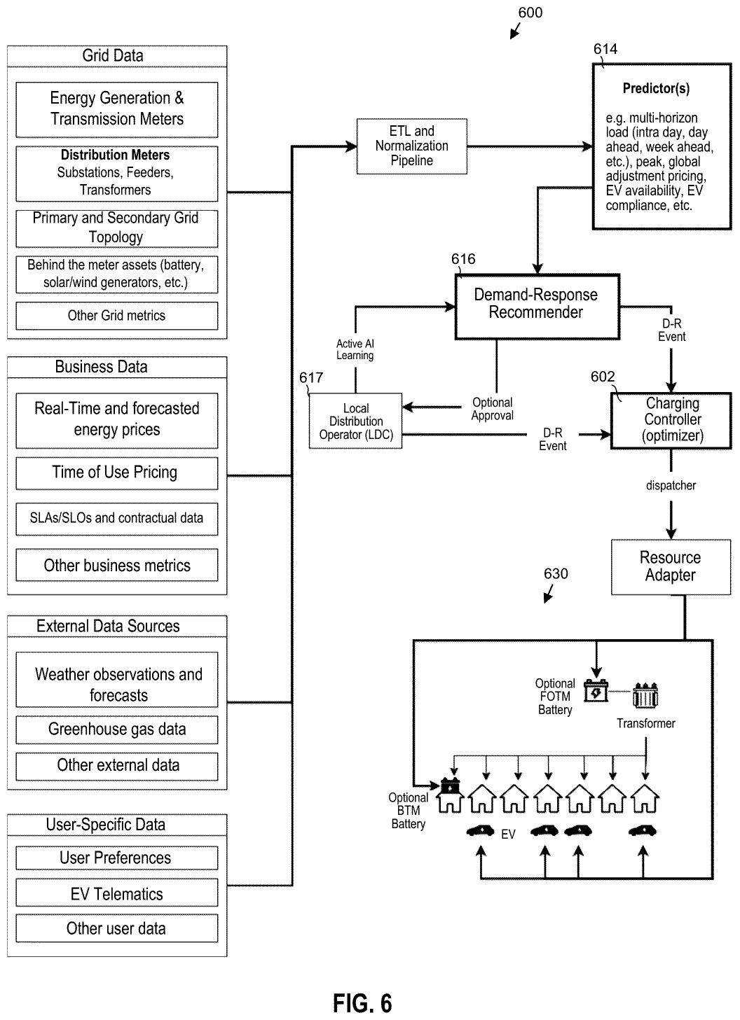

In addition, system 500 may comprise a demand-response recommender 516, which may be involved in load curtailment. Demand-response recommender 516 may be similar to demand-response recommender 616 in FIG. 6.

In addition, system 500 may comprise a resource adapter (RA). In an embodiment, a resource adapter (RA) may be configured to enable communication with or between various types of controllable assets and to possibly separate this communication process from the rest of the system 500. For example, FIG. 4 shows an RA facilitating communications between power grid 530, including components in power grid 530, and the rest of the system 500 including charging controller 502. Each controllable asset may utilize its specific communication protocol, and RAs may serve as intermediaries that facilitate direct communication between the system 500 and these assets. By acting as bridges, RAs may play a role in connecting the system with new resources, granting access, and enabling control. The flexibility of RAs may allow for seamless integration or removal without disrupting the core services offered by the system. Consequently, the system may be able to swiftly adapt to changing environments and requirements by implementing new RAs to incorporate additional controllable assets.

A predictor may predict its target variable(s) over a predefined time horizon or window. In an embodiment, a predictor may be a machine learning based system, and thus may be trained using training data. A predictor may use one or multiple machine learning models to predict some type of information, often referred to as a target or target variable. The training data may include one or more of historical data and live data. A predictor may be retrained at various points in time. In an embodiment, a predictor may comprise a training pipeline and an inference pipeline. A training pipeline may generally refer to a process including one or more of obtaining training data, preprocessing the training data, training a predictor model using the preprocessed training data, and retaining or storing the trained model. A training pipeline may generally collect historical data from any suitable sources, for example from the larger system, including one or more of grid data 520, business data 522, external data sources 524, and user-specific data 526, and so on. Further, historical data may be collected over a preferred horizon, meaning a defined time period in the past, as opposed to using all available historical data. In an example, a training model may use the most recent available historical data over the past one year, or any other suitable time period.

In an embodiment, historical data may comprise of a feature set matrix and a target vector. A feature set matrix comprises a set of data inputs, known as features, which are mapped to predictor or target variable(s) in the target vector.

The preprocessing of training data may include using a data processor, which may perform data cleaning, data conditioning, data warehousing or other operations on received data. The data processor may transform data into a format more suitable for machine learning techniques, such as supervised learning. Additionally, the data processor may perform other tasks such as identifying and removing outliers from the data, filling-in or removing gaps in any of data sources, or applying standardization/normalization/transformation techniques on the data to make the training or inference processes more accurate.

The training of a predictor model may include one or more tasks or operations, for example model selection, hyperparameter tuning, or training of the selected model(s) to develop a mapping between curated feature set matrix and target variable. A predictor model may be a single machine learning model or an ensemble of multiple models.

Once the predictor model has been trained, it may be stored, for example in a file or database in a computing device.

A predictor may be retrained at various points in time, for example on a regular basis or at any other intervals, in an attempt to improve its relevance and accuracy to current operations. Further, a predictor may be retrained when the inference accuracy falls below a predefined threshold, for example in order to use the most recent data for training and correct any drifts between training and inference data. A predictor may be retrained, for example using an ever-increasing supply of data that is incoming from live operations, and subsequently redeployed to continue providing predictor information with improved accuracy. This may in turn provide for greater accuracy or efficiency of the output of an optimizer.

An inference training pipeline may generally refer to a process including one or more of collecting inference data, possibly including predicted data (over a preferred inference horizon), preprocessing the inference data, running the trained model using the inference data, and retaining or storing the predicted target variable. An inference horizon specifies for how far in the future, and possibly at what frequency, the predictions are generated for. As a mere example, the predictions may be made for the next hour, 24 hours, 48 hours, one week and so, at an hourly resolution.

The collecting or acquiring of inference data may be used as input to a predictor. In an embodiment, inference data may only consist of a feature set matrix. In an embodiment, the inference feature set for each predictor may have the same type of data as its training feature set. The inference data may run through the same or similar preprocessing as the training data, as described above. The inference data may then be fed into its most recent trained model to generate a prediction(s) for the particular target variable. Once the prediction(s) for the particular target variable has been generated, it may be stored, for example in a file or database in a computing device.

Charging controller 502 may attempt to control, coordinate, schedule and so on the charging of EVs 540 to reduce the chance that the technical constraints associated with the power grid 530 are violated. Controlling the charging of EVs may take any suitable form and may involve the charging controller 502 generating charging control information. The charging control information may be provided to at least some of the EVs 540 and/or other controllable assets, such as BESSs 534, 536, as well as charging infrastructure. The charging control information may include charging related actions, such as commanding a specific EV when to begin charging, when to stop charging, a charging rate (e.g. current) to be used for charging, a specific charging point(s) that may be used, a charging schedule, EV charging scheduling information, and so on. In addition, the charging control information may include actions for other assets such as BESSs, for example instructions relating to when to start charging/discharging, when to stop charging/discharging, a charging/discharging rate (e.g. current), and so on. In addition, the charging control information may include actions for a plurality of assets in the system, and the actions may be coordinated and/or optimized.

The generating charging control information may be based on any suitable information, for example power flow information from power flow analyzer 504, one or more types of information from one or more of grid data 520, business data 522, external data sources 524, and user-specific data 526, which may first be processed by ETL pipeline 510, predictor information from one or more predictors 514, or information from demand-response recommender 516, and so on. In addition, the generating charging control information may be further based on predicted load information of the power grid, wherein the predicted load information may include a predicted electric load in a section of the power grid, for example in a future time period. In addition, the power flow information may include technical constraint information relating to the power grid, and/or any other type of power flow information in accordance with the present disclosure. Technical constraint information may include operational limit information regarding one or more components in the power grid 530, for example substations, lines, feeders, conductors, transformers, transmission transformers, distribution transformers, where an operational limit may be a maximum rated value of a component (e.g. maximum operating current, voltage, etc.).

The generating charging control information may be based at least in part on an optimization for minimizing violations of the technical constraint information in the power grid. Again, a violation may be an occurrence in which an electrical device or component is operated above an operational limit of the component, or above or beyond some other technical constraint.

Charging controller 502 may provide the charging control information to the EVs and other assets, which may be represented in FIG. 5 as a “dispatcher” signal from charging controller 502 the EVs 540 in the power grid 530, possibly via an optional resource adapter 518.

Charging controller 502 may comprise an optimizer for performing one or more optimizations in relation to controlling the charging of the EVs. An example optimization is to minimize violations of technical constraints information of the power grid. This may involve controlling the charging of EVs such that, for example, charging times, charging dates, charging rates, charging locations or charge points, other scheduling information, and so on, are selected so that the power required for the charging will not cause a violation based on information known and/or predicted about the power grid, for example the known or predicted available load capacities for various points or branches in the power grid. Another example optimization is to minimize the cost of the energy used to perform the EV charging. Another example optimization is to minimize a proportion of the energy used to perform the EV charging that comes from non-renewable sources. Another example optimization is to minimize an amount of greenhouse gas emissions that were produced in generating the energy used to perform the EV charging. Other types of optimizations are also possible and contemplated, such as minimizing the overall peak demand for power in the grid, and minimizing the impacts of charging on the battery life of batteries in the system such as those of EVs or BESSs.

The optimizer generally determines optimal values for decision variables over an optimization horizon, meaning a future time period.

The optimizer may be any suitable type of optimizer, including a machine learning based optimizer, or a mathematical model-based optimizer.

In an embodiment, the optimizer may be a machine learning based system. In a supervised learning based system, model is generated using training data. The optimizer may be trained using historical data and/or live data. The training data may comprise any types of suitable data or information, including but not limited to any of the types of data and information show in FIG. 5 such as grid data 520, business data 522, external data sources 524, and user-specific data 526. An optimizer may be retrained at various points in time, for example on a regular basis or at any other intervals, in an attempt to improve its relevance and accuracy to current operations. Furthermore, the training and retraining of an optimizer may be performed in the same or similar manners as training and retraining of predictors described herein, so far as they are compatible. Thus, these details are not repeated in relation to the training and retraining of an optimizer.

The optimizer may be configured to solve one or more optimization problems related to the charging of EVs and other assets, for example by minimizing or maximizing an objective function. The specific method or algorithm used to solve the optimization problem as the optimizer may depend on the exact formulation of the problem. Generally, an optimization algorithm functions by evaluating the objective function at a set of specific values of its decision variables (for example price points), and doing so for however many different values are necessary to be confident that a set of specific values achieves the objective among those from all possible values (even for which the objective function has not been evaluated) to within a pre-specified tolerance. A difference between optimization algorithms may lie in how they obtain their initial set(s) of decision variable values, how they decide on subsequent decision variable values, and so on. An optimizer may be of any suitable type or types, for example: a linear programming optimizer, a mixed-integer nonlinear programming optimizer, a data driven optimizer, a machine learning based optimizer, a stochastic programming optimizer, etc. Once an optimal value(s) of a decision variable is determined, assets may be controlled based on the optimal value, for example by providing the optimal value and/or indicating actions to assets. Further, optimal value(s) of the decision variable may be transmitted in a signal to one or more other computing devices, such as EVs, other assets, or charging infrastructure.

An optimizer may perform its optimization or other calculation or processing at any suitable times, for example periodically, at non-uniformly spaced time periods, and/or in response to triggering events. For example, the optimization or other calculation or processing may be performed every x second(s), every x minute(s), every x hour(s), or any other suitable time intervals. For instance, the optimizer could be executed every 5 minutes, 15 minutes, 30 minutes, 60 minutes, 2 hours, 3 hours, or at any other times. An example triggering event may be when a parameter exceeds above or drops below a defined threshold, or when a signal is received.

Furthermore, according to an aspect, an optimizer may execute in real-time or near real-time. The optimization may be based on real-time, near real-time, and/or streaming data inputs.

The description relating to an optimizer of charging controller 502 is also generally applicable to other optimizers that may be used or implemented in system 500.

In an embodiment, the system 500 may implement receding-horizon optimization. For example, the charging controller 502 may perform optimization for a single interval or point in time. In another embodiment, the system may involve a receding-horizon optimization scheme. In receding-horizon, which may utilize predictions, the decision variable values may be planned for each point in time or time interval in a horizon into the future, referred to as an optimization horizon. The horizon may start with the current point in time or time interval in the operation of the system, whose decision variable(s) are the only ones taken to perform an action in the system because they pertain to its current state and what is currently feasible. Such optimization may be repeated with each subsequent point in time or time interval, making use of new knowledge of the updated situation for which the optimization is performed, such as a more accurate prediction or an observed value instead of a predicted one. Receding-horizon optimization allows for planning ahead, such as by planning charging-related actions in the near future.

The system 500 may comprise one or more control policies. The control policies of the system may be based on trained machine learning based systems. In this sense, a control policy may be part of a control agent. A control agent observes its environment, herein referred to a control environment, and takes action based on its observations, or percepts, of the control environment. The taking of action is referred to as controlling the system. Depending on the state of the environment, taking action may involve taking no action at all, for example if there has been little or no change in the state since the last time the agent took action. Thus, doing nothing is a valid action in a set of actions in the action space of the controller. In an embodiment, the present systems and methods may exploit the flexibility of controllable assets in the system to achieve improved performance of the system. For example, the flexibility of controllable assets may be exploited in response to changes in the control environment.

FIG. 6 is another example control system 600 according to the present disclosure. FIG. 6 details in particular some aspects of the demand-response recommender 516 from FIG. 5. Some parts of system 600 are similar to those of system 500 in FIG. 5, and descriptions of these are not repeated.

Control system 600 may generally comprise, in part, a charging controller 602, one or more predictors 614, a demand-response recommender 616, and a local distribution company or operator (LDC) interface 617. Interface 617 enables system 600 to interface with an LDC, for example via an application programming interface or in any other suitable manner.

Demand-response recommender 616 may be involved in at least load curtailment. In an embodiment, system 500 or 600 may include a power negotiation tool for an amount of power requested for load curtailment. The negotiation may be between a system operator and a local distribution company (LDC), sometimes called a local electricity utility. A system operator generally operates and manages a power system or grid. Load curtailment generally refers to a reduction in system load to avoid or to reduce an overload in the system, for example when the load in the system is, or is anticipated to be, higher than the total available power. A request for load curtailment may be a request from a system operator to customers to temporarily reduce their load during a defined period of time. The demand-response recommender 616 may proactively generate recommended load curtailment events, which may be referred to as demand-response (D-R) events, which may be in the form of, or include, recommended load curtailment information, to the system operators, before the load reaches critical levels. Recommended load curtailment information may include any suitable information, for example when load curtailment should occur, how much load should be curtailed, and where the load curtailment(s) should occur in the grid or system. Recommended load curtailment information may be generated or otherwise provided by recommender 616 to charging controller 602. In addition, recommended load curtailment information may be generated or otherwise provided via LDC interface to charging controller 602. The recommended load curtailment information may be used by charging controller 602 to control the charging of EVs and other assets. For example, if grid load is to be reduced in a part of the grid that affects charging of EVs or other assets in response to recommended load curtailment information, the charging controller 602 may take this information into account when generating charging control information for controlling the charging of EVs and other assets. For example, the charging of some EVs may be scheduled during time periods when there is no load curtailment, or during time periods where there may be load curtailment but where the charging may still be done for example where there may be some capacity. Thus, the generating of charging control information may be based on the recommended load curtailment information. In addition, the recommended load curtailment information may be provided to the power grid 630, for example to an operator of the power grid. In addition, the recommended load curtailment information may be provided to a power flow analyzer, and where the determining of power flow information of the power grid may be based on the recommended load curtailment information.

In an embodiment, recommender 616 may use predictions from one or more predictors 614 to generate the recommended load curtailment information. For example, predicted information may be include predicted load information of the grid, which in turn may be affected by known and/or predicted and/or scheduled charging of EVs or other assets in the grid which may come at least in part from charging controller 602.

Additionally, recommender 616 may utilize statistical and/or machine-learning models to, for example, learn from system operators (e.g. power grid operators) and LDCs electricity requests and counter-offers in an electricity market. The recommender 616 may generate the load curtailment information based at least partly on the learned information relating to the system operators and/or LDCs.

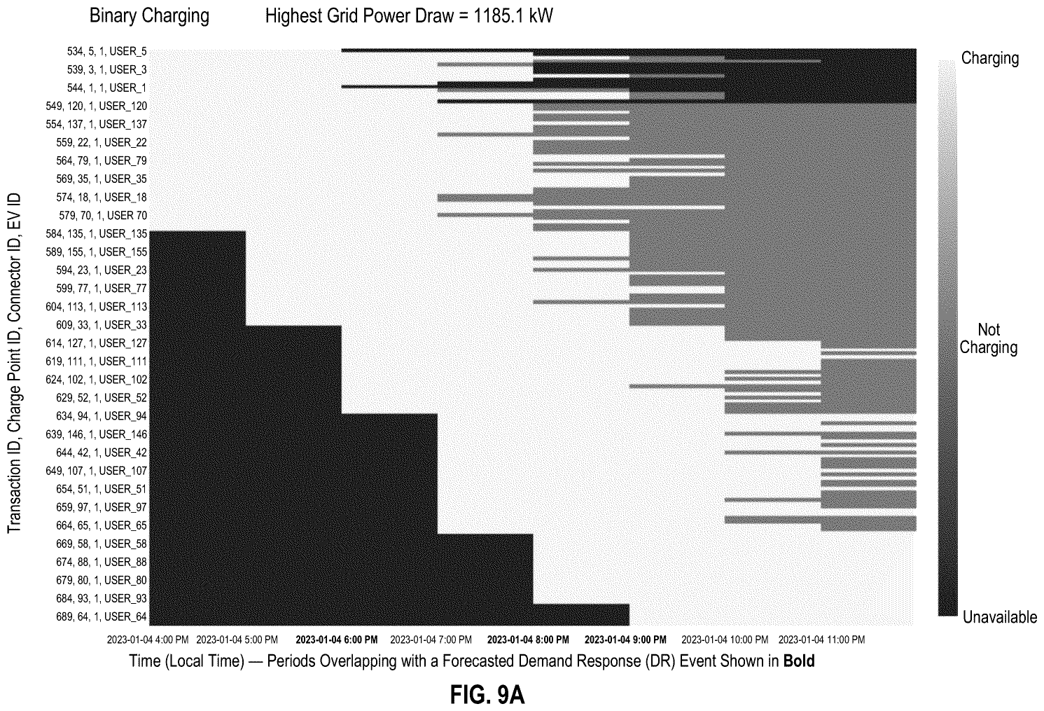

In an embodiment, recommender 616 may provide the system operators and/or LDCs with a maximum power available for load curtailment. The maximum power available for curtailment may be the current observed power, or the predicted power if the curtailment event is scheduled in the future. A maximum amount of load curtailment may be based on constraints of the power grid and EV user availability. In addition, recommender 616 may provide system operators and LDCs, for example via interface 617, with a time window to execute a load curtailment. The time window and the maximum power available may be parameters used to recommend demand-response events to system operators. A maximum power available for load curtailment and time window information may be part of the recommended load curtailment information. The events may be automatically sent to the charging controller 602 for dispatching, or optionally validated by the system operator before dispatching. The optional validation by the system operator may confirm the recommended event as-is, or reject the event, or update the parameter of the demand-response event before confirming it. In all 3 cases, the validation may be used as input to active learning models, including but not limited to reinforcement learning and collaborative filtering, to, for example, learn new load patterns, specific LDC preferences in the power grid and fine tune recommendations to improve their relevance to the LDCs based on feedback of the system operators. In an embodiment, the active learning techniques may be used to fine tune a dynamic AI-based threshold, for example as illustrated in FIG. 8.

It is noted that the labels “Active AI Learning”, “Optional Approval”, “D-R Event”, and “dispatcher” in FIG. 6 are merely some examples of information that may be contained in communications or other information sharing; they are not meant to be limiting in any way.

According to the present disclosure, some embodiments go beyond basic use cases for peak shaving and peak shifting. In some embodiments, individual users can specify their desire to opt in/out of EV charging demand response programs, and a charging controller may coordinate EV users and optimize and regulate the load on a power grid. In some embodiments, a charging controller considers optimization of power flow within circuits in the power grid.

In an aspect, the present disclosure is directed to an end-to-end system to adapt and optimize, optionally in real-time, the charging of EVs and other assets, from data collection to power dispatches.

In an embodiment, a system may be used to collect or store or visualize streaming and/or historical performance metrics about the system, for instance power load, voltage measurements, states of charge (SOCs), and so on.

In an embodiment, a system may be used by a system operator which is responsible for the overall power system operation in a specific location (for example IESO in Ontario and CAISO in California) to request the amount of power from aggregators. In general terms, an aggregator is a group of agents in a power system which acts as a single entity when engaging in an electricity market.

In an embodiment, a system may be used by aggregators to send their bids, confirm the requested power, and take responsibility for the bid.

According to an aspect, a system according to the present disclosure may indicate or use best time(s) to charge an EV based on how environmentally friendly the current charging is based on the amount of energy coming from the power system provided by renewable energy sources in the power system such as wind, or solar energy.

In addition, according to an aspect, a system according to the present disclosure may prioritize the usage of renewable energy over non-renewable energy, for example to be more environmentally friendly.

Furthermore, according to an aspect, a system according to the present disclosure contributes to power system parameter control such as voltage or power control by directly influencing the customer and reducing the consumption from their end.

In an embodiment, a system may be integrated with a system operator and control appropriate assets in the system, including EVs and/or BESSs, which may be located in front of the meter or behind the meter.

In an embodiment, data collected by the system may be used to predict energy demand (load predictors). Load predictors may use live and historical load information to predict the power system load of the future at any arbitrary forecast horizon, for example 1 hour ahead or 1 day ahead. This load predictor may leverage machine-learning (ML) techniques, including, but not limited to tree-based models, Deep Neural Networks, Recurrent Neural Networks and any combination of one or more ML models using ensembling and/or boosting techniques. This prediction may be implemented to anticipate possible load peaks in the upcoming future and prepare or recommend a request of load curtailment before the actual peak time in a service area for example a neighborhood or a power system.

In an embodiment, a user profile predictor will predict the behaviour of EVs in the future based on their behaviour in the past, for example EVs charging and discharging behaviour, EVs driving profile, past departure and arrival depending on the days of the week or weather conditions, and so on.

In an embodiment, a charging controller, which may include a model, may predict optimal times for EV charging based on one or more of historical and/or current and/or predicted energy supply (which may include total supply and the supply for different types of energy sources), an electrical demand in the power system, and optionally other technical and/or business metrics such as contracted rates, service level agreements (SLAs), penalties, and the like. The model may indicate favorable conditions for charging, to maximize the utilization of clean energy and minimize the impact on the power system. In an embodiment, a system or method is configured to optimize for power flow in a power grid. Data collected by the system, which may include in particular power, current, and voltages, may be used for power flow analysis, which may provide different power system parameters in several locations to system operators.

According to an aspect of the present disclosure, a system is provided to assist power system operators to manage a power system network in real-time to reduce a peak of the transformers or feeders overloading, for example by adjusting the EV charging patterns and/or implementing BESS on the feeder(s). In at least one embodiment, the system comprises an end-to-end automated framework interconnected with aggregators and system operators. The system may allow for the collection of relevant streaming and historical data about the power system, as well as to send optimal power bids and commands to an EV charging management system. In at least one embodiment, a distributed cloud platform is provided that collects data from devices and sensors deployed in a power grid or other system, such as a smart grid, runs artificial intelligence (AI) models, and sends control signals back to the smart grid. In at least one embodiment, the system comprises AI-based predictors and optimizers. The predictors may provide insight into the future state of a power system, and the optimizer may leverage the data collected by the system to optimize the power flow to charge EVs while minimizing the impact on the power system. In an embodiment, it may include an end user mechanism for EV owners to interact with systems such as to register, enroll, opt in/out, and monitor their contributions to the power system and environment.

In an embodiment, the system enables users to select and apply models with best performance dynamically based on real time data.

An example embodiment of a system platform according to the present disclosure is now described.

In an embodiment, a system may include a stakeholder interface mechanism for different contributors and stakeholders in the system such as the system operator, LDCs, charging controller, and so on. The stakeholders may be able to request a load curtailment from their end and see the approval process. In addition, they may be able to negotiate and communicate with each other regarding the amount of the requested load curtailment power or the price of the requested power. For example, a system operator may request 200 kW of power from an LDC, and the LDC can send a counteroffer of 100 kW to the system operator to confirm. Another example is that a system operator may send a load curtailment request to an LDC, and the LDC may reject the load curtailment request. Another example is that an LDC may send a load curtailment request to a charging controller, and the charging controller sends a counteroffer to an LDC, and then the LDC may accept or reject the counteroffer. The stakeholders may be able to monitor the ongoing events in the system such as the load, generation, number of connected and charging EVs, SOC of BESS, the load prediction for the upcoming hours and days, and so on.

In an embodiment, the system may perform one or more of the following: handling connection and data exchange between an end user interface mechanism, a stakeholder interface mechanism, databases, platforms, and/or devices or smart sensors of a smart grid; handling automation of data collection from devices and smart sensors deployed in a smart grid (for example smart meters, EV chargers, etc.); pre-processing incoming data from smart meter devices into a format that is ingestible by machine learning or AI models; performing AI model inference to generate predictions to provide insight into the future of a smart grid (for example electrical demand predictions, EV charging demand predictions, rooftop solar panel generation predictions, etc.), and the output of multiple AI predictions may be fed into a single optimizer, or multiple optimizers; feed the output of AI predictions into optimizers in order to perform some intelligent action (for example strategic control of EV chargers) in order to take advantage of insight provided by predictions; take the output of optimizers to generate control signals that are sent back to devices or assents.

In an embodiment, a system may be configured with multiple objectives such as reducing greenhouse gas emission, peak shaving, etc. If multiple conflicting optimizers are utilized, then another layer of logic may be provided to choose the best or otherwise desirable course of action for the controls sent to the devices.

In an embodiment, a system may perform one or more of the following: coordination of multiple subsystems, assets, devices, and/or sensors across geographic distances, for example large distances, deploying configuration and/or orchestrating activity of the subsystems; deployment, provisioning, and/or configuration of subsystems; performing AI model training and/or other compute-intensive tasks; deploying configuration and/or new AI models; running web servers which may serve as the front-end for interface with the platform (for example configuration, deployment, web dashboards, smartphone apps); and periodically sync with subsystems to collect cached data from subsystems and store historical data in a database. Loading prediction and asset scheduling can be done in real-time, or in batch every day. The prediction of each day, or other time period, may be fed to the optimizer to run the asset scheduling for the next day, or other time period, and then, the results may be sent to assets to act accordingly.

Also, in an embodiment, a subsystem may be tasked with performing operations such as training one or more AI or machine learning systems for use in predicting one or more parameters, as well as processing, cleaning, and/or storing data. The system may generally comprise, in at least one embodiment, one or more of a data processor module, database or data repository, data analysis module, estimator or predictor training module, and/or one or more optimizer training module.

A cloud platform subsystem of the system may be tasked with, among other things, performing inference operations of one or more AI systems for the prediction of one or more parameters, such as EV charging demand, loads, weather, renewable energy generation, etc. A subsystem may generally comprise, in at least one embodiment, one or more of a data processor, a predictor, and an optimizer. In one or more embodiments, at least part of the system may be implemented using cloud based computer resources.

Some further example optimizers according to one or more embodiments are now described. An optimizer may be an AI-based or machine learning based optimizer.

In an embodiment, after data is received and stored in a database such as weather, load, EV user preferences, and BESS data, the data may be cleaned and pre-processed and adjusted to make it more usable for the algorithms, optimizers, and predictors. After preprocessing the data by the system, at least some of the data may be fed into one or more predictors, for example day-ahead load, user profile, global adjustment, price, and other predictors to predict what is going to happen in the future. Then, these predictions may be used by optimizers in the system, for example to determine best or otherwise desirable set points for the decision variables in, for example, local loops such as the amount of charge and discharge of BESS and EVs in different hours. A local loop may generally refer to any “last mile” connection to customers, for example in a power system. After gathering prediction information relating to load and optimizing and scheduling BESS and EVs, a schedule may be sent, for example to a resource adapter (RA) and connectors, in order to activate EV telemetric and/or charger partners and BESS to charge or discharge accordingly. An optimizer may continuously or from time to time receive prediction information relating to loads, or to any other item, and feed it to an optimizer to, for example, react to load fluctuations and/or to update a schedule accordingly.

In at least some embodiments, one or more optimizers or predictors may be AI based, or machine learning (ML) based.

One or more predictor modules, or just predictors for short, in one or more embodiments according to the present disclosure are now described.

Data may be collected from devices and sensors deployed in the power system, for example including substation and transformer data, market pricing data, BESS data, EV charger data, weather forecasts, observation data, and so on. Data from devices and sensors may be provided to various predictors, which may be AI based, for example to provide insights such as renewable energy predictions, EV charging demand predictions, electricity demand predictions, power flow analysis, power system loading, electricity peak predictions, and so on.

The system may comprise one or more optimizers. An optimizer may be a power flow analyzer or charging optimizer or an integration of both.

Determining optimal power flow (OPF) in one or more embodiments according to the present disclosure is now described. OPF may be performed or facilitated by power flow analyzer.

A power system, such as a local distribution utility or other transmission systems may provide circuit topology information of the power system, which may be modeled in, or converted into, a form that is readable by the platform, for example OpenDSS format. Power flow along the circuit lines and transformers in the power distribution system may be calculated, for example in real time, using the output of live sensor data, and/or output of predictions. Calculated or determined power flow information about the power system may be used in any suitable manner, for example to identify segments of the circuits that may be overloaded now, or in the future. Overloading of segments may refer to overloading of transmission lines or other conductors, of transformers, or of any other devices or components in the grid. A power flow analyzer may perform optimization in order to calculate ideal path(s) for power to flow, for example to mitigate overloading.

An example optimizer for a charging controller in one or more embodiments according to the present disclosure is now described.

An optimizer may provide control and management in relation to one or more EVs and/or ESSs. Control may involve setting and actioning EV and/or ESS charging patterns, although other forms of control are possible. Inputs to a BESS/EV optimizer may include any suitable information, for example one or more of EV user preferences, such as a preferred SOC, departure time and so on as constraints, as well as the output of the predictors and live and/or historical data of a power system parameters such as power, voltage, or current and/or power system assets such as EVs and BESS and the amount of renewable energy generated in the system. The optimizer may perform an optimization based on one or more configured objectives. Results of the optimizations may be used to intelligently control assets in the system, including EVs or BESSs, for example to generate charge and discharge patterns for BESS and EVs. An optimizer may generate a signal indicating actions to be taken by controllable assets in the system, for example EVs, or charging infrastructure, such as ESSs or EV charge points, and so on. A mere example action may be to charge a specific EV at a specific charge point during a specific date/time, and possible at a specific charge rate(s).

In an embodiment, power flow analyzer may receive power system topology information, for example relating to transformers, lines, and/or geographical locations of different elements in the power system as well as load information such as active and reactive power of the end customers at different points or regions of the grid. The power flow analyzer may be configured to determine variables of the power system such as voltage, current, power and their angle and magnitude. This may be particularly useful when direct instrumentation of those values is not possible or practical. The variables may be calculated by the power flow analyzer, and meters in the power grid may collect readings relating to these and the readings may be verified against the calculated variables. The power flow analyzer may be configured to identify or determine constraints and/or flexibility of the power system, for example to stay within one or more predetermined thresholds. Constraints may include technical electrical constraints, such as maximum rated values for various components in the power system, for example maximum voltage or current ratings for a transformer, maximum generation of power plants, as well as business constraints such as SLAs and other contractual requirements. For example, if power flow determines that a transformer is loaded at 75% of the nominal power, it means that 25% of the transform capacity is available for extra loading and power consumption. A determination of variables of the power system, constraints, or flexibilities by the power flow analyzer may be done by minimizing an objective function. An objective function may include a variety of quantitative metrics. Example metrics may include transformer overload conditions, overall health of the power system (for example number of voltage and overloading violations), target maximum load and/or stability of the power load during peak/off-peak periods, energy production breakdown by type (for example wind/solar, nuclear, gas/coal, etc.) to maximize the usage of renewable energies, and business metrics (for example power prices, BESS costs, carbon tax costs, etc.).

In an embodiment, the system may comprise one or more charging controllers, which may generally provide one or more of control, management, scheduling, planning, and so on, in relation to EV charging/discharging and optional ESS charging/discharging. For simplicity, these functions and others will generally be referred to simply as providing charging control. The charging controller may comprise an optimizer, for example for performing optimizations for one or more objectives in relation to providing charging control. The optimizer may receive information from one or more the power flow analyzer, load predictors, live or historical data of the loads, information indicating at a particular location and time (now or future prediction) when it is best to charge an EV to use power generated with low or lowest emissions (e.g. greenhouse gas emissions), BESS SOC, energy price, and user profile predictor and preferences in order to generate charging control information, which may include decisions, possibly optimal decisions, regarding the operation of EVs and BESSs, for example to charge or discharge, when to charge, at what rate to charge, where to charge (e.g. which charge point), and so on. The term BESS/EV optimizer may generally refer to an optimizer that optimizes, or performs other operations, in relation to controlling EVs and/or ESSs, including charging and discharging patterns, which may include dates and times of charging, charging rates, particular charge points, and so on.

In general, some embodiments are described with reference to EVs for simplicity. However, it is to be appreciated that the references to EVs are generally intended to refer to any controllable asset, including BESSs. Thus, references to EVs is not limiting.

As depicted in FIG. 4, a charging controller and a power flow analyzer may operate together, possibly iteratively. The power flow analyzer may determine initial variables of the power grid or system at a time TO. Then the output of one or more of the power flow analyzer, load predictors, user profile predictor and preferences, BESS SOC, energy price and so on may be provided to the charging controller to determine an optimal dispatch of the EVs and BESSs behavior and send charging control information, which may include charging related actions or commands (for example charge/discharge/stop charging and so on) at time TO. Those dispatches will typically impact the load in the power grid, as well different variables of the power grid since some EVs and BESSs may begin charging while others may stop charging, which will affect the load on the power system. Information from the charging controller, for example at least some of the charging control information, may be provided to the power flow analyzer, which may determine new power flow information for a subsequent period, for instance time T1, based at least on some of this information. In addition, information provided back to the power flow analyzer may include information on how EVs, such as EVs and BESSs, responded to charging control information from charging controller. For, example, this may include whether an EV followed a charging command, for example a time to charge, a charging rate to use, a charging duration to observe, a location at which to charge, and so on. In addition, this information may include any other information relating to if and how an EV charged or discharged, or to any status or other information relating to the asset. This information may be used by the power flow analyzer since it may provide more accurate information about actual charging actions by the EVs, compared to the charging control information which may only include charging commands to EVs, which may or may not be followed. The information may also include or indicate other information such as the actual impacts on the power grid, for example load, of the actual EV charging actions. The new power flow information may be provided to the charging controller at or for a subsequent time period or iteration. An iterative feedback loop may continue for future time periods or blocks such as t2, t3, and so on.

A data integration platform, which may include RAs, may take output of a charging controller, power flow analyzer, or optimizers (OPF, optimizer and so on) to generate control signals that are sent back to BESSs, EVs, or an EV charger controller.

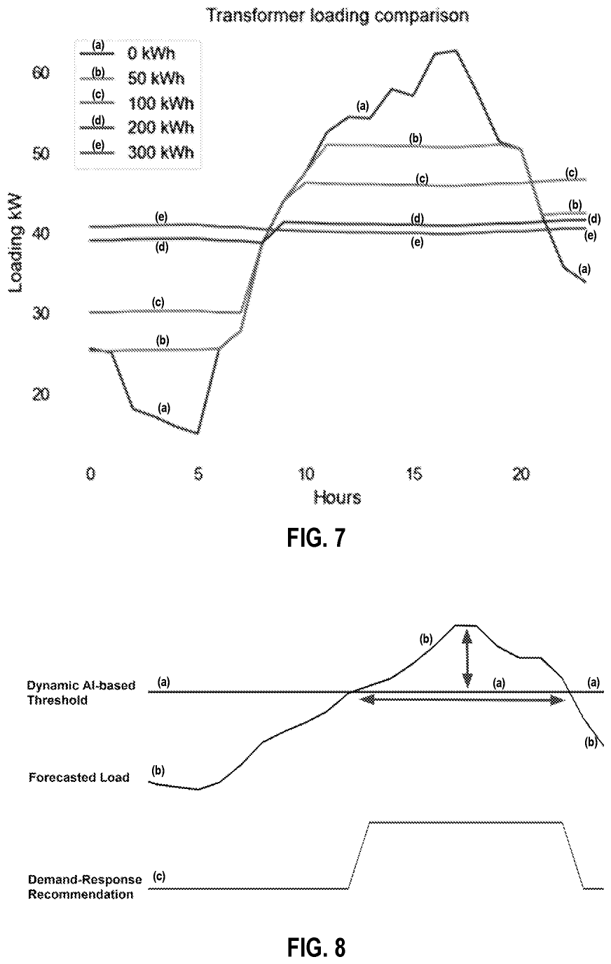

FIG. 7 is a graph showing loading versus hours in an example scenario. The graph shows how an example system may effectively leverage batteries with different capacities to shave the load during peak hours. In the example, higher capacity batteries (200-300 kWh) can very effectively reduce the maximum load and flatten the load curve on a transformer when intelligently controlled. Depending on the transformer and the application, smaller batteries (50-100 kWh) are cost-effective and can significantly reduce load peaks when optimally managed.

An example charging controller optimizer in one or more embodiments according to the present disclosure is now described.

The output of one or more predictors, for example energy demand predictions, OPF, etc., may be provided as variables or information into an optimizer in order to perform some intelligent action. Intelligent action may be of any suitable type, for example strategic control of EV chargers, strategic control of BESS, etc., in order to take advantage of insight provided by predictions. A charging controller may receive output of a power flow analyzer, and optionally predictors or other information, to make optimal decisions regarding the control of EVs or other assets in the system. An optimizer may seek to charge or discharge the EVs in order to meet various objectives, such as minimizing transformer overload, energy dependent peak shifting, energy arbitrage, etc. The system may take output of optimizers to generate control signals that are sent back to EV charge points. If multiple conflicting optimizers are utilized, then ensemble or boosting methods may be used to choose the best or otherwise desirable course of action for the controls sent to the assets.

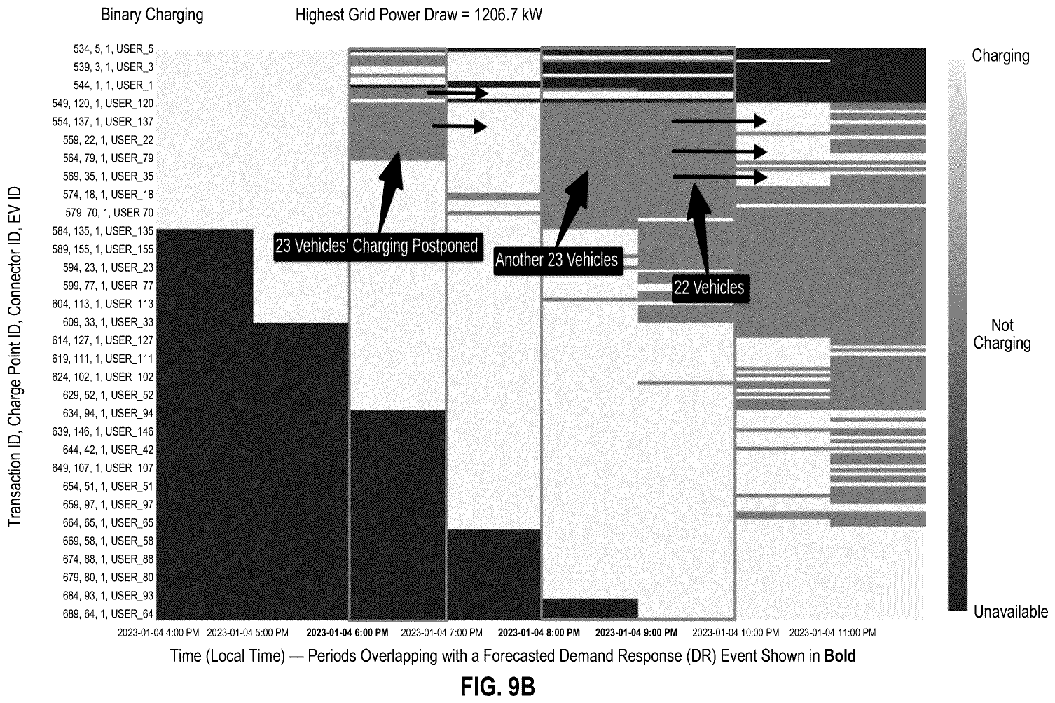

FIGS. 9A-B show examples of EV charging control or scheduling in which 178 EVs are considered to be present in the system. FIG. 9A shows a situation without a charging controller according to the present disclosure, which means the EVs charge without intelligent control. FIG. 9B shows a situation in which a charging controller according to the present disclosure is used, where a charging controller optimizer is operating and managing the charging of EVs. The optimizer intelligently may send charging or stop charging signals to EVs, for example considering load curtailment requests (also known as demand-response (DR) events) coming from the system operator or LDCs or a DR event recommendation from the EV charging controller. In this example, three blocks of DR events as large as 160 kW are shown. Charging controller optimizer may postpone the charging of 23 EVs (each charging 7.2 kWs) to later hours to reduce the load of the system at the time the DR event is requested. This illustrates how a charging controller may control the charging of EVs and other assets based on demand-response event information, for example recommended load curtailment information. In this example, a charging controller schedules timing for EV charging based at least in part on recommended load curtailment information. A result is that the timing of charging of at least some EVs is modified based on recommended load curtailment information.

The present disclosure provides various improvements relating to charging EVs, including by providing strategic charging scheduling and/or power flow management in power distribution systems.

The charging of EVs may add a very significant load to the infrastructure of power distribution systems, in particular during peak hours. The present disclosure provides several aspects to attempt to mitigate this additional load induced by EVs on distribution system infrastructure and to enable their deployment as a viable and cost-effective alternative to traditional internal combustion engine vehicles.

An intelligent charging controller optimization to the last few kilometers of the distribution grid may reduce the load of the transformers and lines by locally providing the energy to the loads during peak hours using BESS and reducing the flexible loads such as EVs and EV chargers, leading to peak shaving and a reduction in the maximum loading.

In an aspect, teachings according to the present disclosure may help prioritize and/or postpone a costly expansion of a distribution system including the lines and transformers. It may be cost prohibitive to upgrade may of the lines and transformers for residential areas in order to support rapid proliferations of EV charging and account for worse case-scenarios. By analyzing behavioral patterns, including by leveraging AI or other machine learning techniques, including short/long term seasonal trends, methods and systems according to the present disclosure may maintain the power system within desired, standard, and safety limits in an effective manner, reduce the need to oversize the grid to support worse case scenarios (such as high peaks), and/or allow power system operators to plan more effectively long-term cost-effective expansion of the distribution network by receiving the load curtailment requests from system operators or LDCs, predicting future characteristics of the system such as load, EV user profile, renewable energy generation and so on and then, understanding the conditions of the system using OPF and then feeding these information into a charging controller optimizer to send the commands to the EVs and BESSs in the system via different modules in the system such as RAs and finally storing the variables of the system such as voltage, current, SOC, power, etc. in a data storage center.

In addition, adding EVs with high penetration levels generally increases the power consumption in a power grid, leading to an increase of the flowing power through the transformers, heating them up, and reducing their lifetime. In an aspect, teachings according to the present disclosure may help the power grid avoid overloading and a need to expand the transformers and lines by optimizing the charging of EVs (curtailment) and discharging the stored energy in BESS at the peak time so that the power flowing through the transformers and lines does not exceed their maximum operating thresholds, thereby prolonging the life expectancy of the transformers and reducing power outages.

Moreover, the present disclosure may assist EV owners charge their EV when renewable energy resources are vastly available to reduce the emission and global warming.

An end user interface mechanism, for example for customers, may allow EVs to be registered, for example by owners, in a service so that the EV may be monitored and controlled. In addition, the EV owner may be able to opt in/out of the load curtailment program, meaning that they can remove or grant access to the system operator to control their EV. Moreover, the users may be able to see how much they are contributing to the usage of clean energy by charging their EV when renewable energy is widely available. The customers may also be able to start and stop charging manually in this interface. Examples of an end user interface include a mobile app, an interface directly within an EV, smart panels and so on.

A programmatic interface may allow different components of the system to communicate, read, write, send commands and so on. For example, a programmatic interface may enable communication between different stakeholders, such as system operators, LDCs or energy market participants, on the system via a stakeholder interface mechanism, reading and feeding live data coming from an LDC, system operator, or weather data provider, predicting the load and user profile, sending commands from an optimizer to a data integration platform and/or RA, reading data from and sending commands to EVs and BESSs, and data storage in a database.

FIG. 8 is a graph illustrating an example of a function or operation at demand-response recommender 616, in which the load of the next day is predicted and compare to a specific threshold to determine how much load curtailment is needed for the next day. In FIG. 8, line (a) represents a dynamic AI-based threshold which is basis of the comparison, while line (b) is the forecasted load of the next day. Line (c) is a demand response recommendation, which in this example is a comparison of the forecasted load and dynamic AI-based threshold in which the height of the figure is equal to the difference of peak forecasted power and the dynamic AI-based threshold and the width of the figure is equal to the time duration when the forecast exceeds the threshold. The dynamic AI-based threshold may be fine tuned using active learning techniques and feedback from the operators and LDCs.

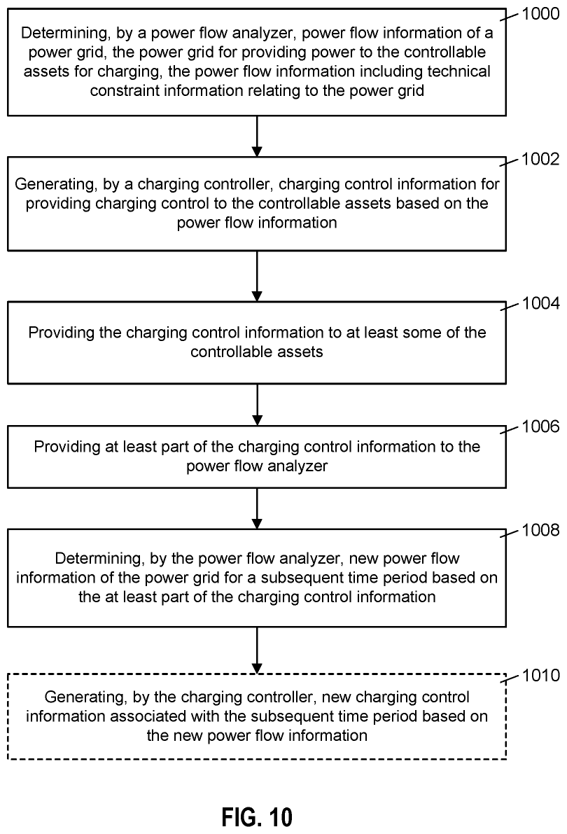

FIG. 10 is a process flow diagram of an example method according to the present disclosure relating to providing control to a plurality of electric controllable assets which include at least some electric vehicles (EVs). The example method may be performed at or by one or more electronic devices each having one or more computer processors and computer-readable memory.

At block 1000, the method may involve determining, by a power flow analyzer, power flow information of a power grid, the power grid for providing power to the controllable assets for charging, the power flow information including technical constraint information relating to the power grid.

At block 1002, the method may involve generating, by a charging controller, charging control information for providing charging control to the controllable assets based on the power flow information.

At block 1004, the method may involve providing the charging control information to at least some of the controllable assets.

At block 1006, the method may involve providing at least part of the charging control information to the power flow analyzer.

At block 1008, the method may involve determining, by the power flow analyzer, new power flow information of the power grid for a subsequent time period based on the at least part of the charging control information.

At block 1010, the method may optionally involve generating, by the charging controller, new charging control information associated with the subsequent time period based on the new power flow information.

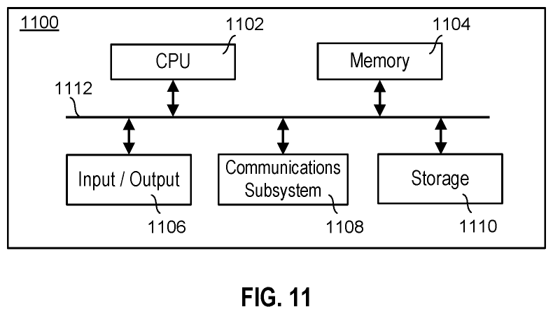

FIG. 11 is a block diagram of an example computerized device or system 1100 that may be used in implementing one or more aspects or components of an embodiment according to the present disclosure. For example, system 1100 may be used to implement a computing device or system, such as a charging controller or power flow analyzer or predictor or demand-response recommender, and so on, to be used with a device, system or method according to the present disclosure. Thus, one or more systems 1100 may be configured to implement one or more portions of one or more systems or devices according to the present disclosure. This includes a center subsystem and/or edge subsystem. Furthermore, a system 1100 may be configured to implement a computing device system at an EV or at a home or other building, for example to enable control over EV charging or to acquire user input.

Computerized system 1100 may comprise one or more of classic, analog, electronic, digital, and quantum computing technologies. Computerized system 1100 may include one or more of a computer processor device 1102, memory 1104, a mass storage device 1110, an input/output (I/O) interface 1106, and a communications subsystem 1108. A computer processor device may be any suitable device(s), and encompasses various devices, systems, and apparatus for processing data and instructions. These include, as examples only, one or more of a hardware processor, a digital processor, an electronic processor, a graphics processor, a quantum processor, a programmable processor, a computer, a system on a chip, and special purpose logic circuitry such as an ASIC (application-specific integrated circuit) and/or FPGA (field programmable gate array). In addition, system 1100 may include hardware dedicated to one or more specific purposes, such as a graphics processing unit (GPU), or a tensor processing unit (TPU) or other artificial intelligence accelerator ASIC, for example for machine learning (ML).

Memory 1104 may be configured to store computer readable instructions, that when executed by processor 1102, cause the performance of operations, including operations in accordance with the present disclosure.

One or more of the components or subsystems of computerized system 1100 may be interconnected by way of one or more buses 1112 or in any other suitable manner.

The bus 1112 may be one or more of any type of several bus architectures including a memory bus, storage bus, memory controller bus, peripheral bus, or the like. The computer processor 1102 may comprise any type of electronic data processor, such as a central processing unit, or a graphical processing unit. The memory 1104 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 1110 may comprise any type of storage device configured to store data, programs, and other information and to make the data, programs, and other information accessible via the bus 1112. In particular, device 1110 may be configured to store one or more of repositories/databases. The storage device may be adapted to store one or more databases and/or data repositories, each of which is generally an organized collection of data or other information stored and accessed electronically via a computer. The term database or repository may thus refer to a storage device comprising a database. The mass storage device 1110 may comprise one or more of a solid state drive, hard disk drive, a magnetic disk drive, an optical disk drive, or the like. In some embodiments, data, programs, or other information may be stored remotely, for example in the cloud. Computerized system 1100 may send or receive information to the remote storage in any suitable way, including via communications subsystem 1108 over a network or other data communication medium.

The I/O interface 1106 may provide interfaces for enabling wired and/or wireless communications between computerized system 1100 and one or more other devices or systems, such as an electric vehicle charging control system. Furthermore, additional or fewer interfaces may be utilized. For example, one or more serial interfaces such as Universal Serial Bus (USB) (not shown) may be provided. Further, system 1100 may comprise or be communicatively connectable to a display device, and/or speaker device, a microphone device, an input device such as a keyboard, pointer, mouse, touch screen display or any other type of input device.

Computerized system 1100 may be used to configure, operate, control, monitor, sense, and/or adjust devices, systems, and/or methods according to the present disclosure.

A communications subsystem 1108 may be provided for one or both of transmitting and receiving signals over any form or medium of digital data communication, including a communication network. Examples of communication networks include a local area network (LAN), a wide area network (WAN), telecommunications network, cellular network, an inter-network such as the Internet, and peer-to-peer networks such as ad hoc peer-to-peer networks. Communications subsystem 1108 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1374), Thunderbolt™, WiFi™ (e.g. IEEE 802.11), WiMAX (e.g. IEEE 802.16), Bluetooth™, or Near-field communications (NFC), as well as General Packet Radio Service (GPRS), Universal Mobile Telecommunications System (UMTS), Long-Term Evolution (LTE), LTE-A, 5G NR (New Radio), satellite communication protocols, and dedicated short range communication (DSRC). Communication subsystem 1108 may include one or more ports or other components (not shown) for one or more wired connections. Additionally or alternatively, communication subsystem 1108 may include one or more transmitters, receivers, and/or antenna. Further, computerized system 1100 may comprise clients and servers (none of which are shown).

Logical operations of the various embodiments according to the present disclosure may be implemented as (i) a sequence of computer implemented steps, procedures, or operations running on a programmable circuit in a computer, (ii) a sequence of computer implemented operations, procedures, or steps running on a specific-use programmable circuit; and/or (iii) interconnected machine modules or program engines within the programmable circuits. The computerized device or system 1100 of FIG. 11 may practice all or part of the recited methods or operations, may be a part of systems according to the present disclosure, and/or may operate according to instructions in computer-readable storage media. Such logical operations may be implemented as modules configured to control a computer processor, such as processor 1102, to perform particular functions according to the programming of the module. In other words, a computer processor, such as processor 1102, may execute the instructions, steps, or operations according to the present disclosure, including of the one or more of the blocks or modules. For example, one or more of modules or blocks shown in any of the other figures, or described herein, for example charging controllers, optimizers or predictors, may be configured to control processor 1102. At least some of these blocks or modules may be stored on storage device 1110 and loaded into memory 1104 at runtime or may be stored in other computer-readable memory locations.

Computerized system 1100 of FIG. 11 is merely an example and is not meant to be limiting. Various embodiments may utilize some or all of the components shown or described. Some embodiments may use other components not shown or described but known to persons skilled in the art.

The concepts of real-time and near real-time may be defined as providing a response or output within a pre-determined time interval, usually a relatively short time. A time interval for real-time is generally shorter than an interval for near real-time. Mere non-limiting examples of predetermined time intervals may include the following as well as values below, between, and/or above these figures: 10 s, 60 s, 5 min, 10 min, 20 min, 30 min, 60 min, 2 hr, 4 hr, 6 hr, 8 hr, 10 hr, 12 hr, 1 day.

In some embodiments, algorithms, techniques, and/or approaches according to the present disclosure may be performed or based on artificial intelligence (AI) algorithms, techniques, and/or approaches. This includes but is not limited to predictors and/or optimizers according to the present disclosure, as well as controlling of assets.

In some embodiments, the AI algorithms and techniques may include machine learning techniques.

Machine Learning (ML) may be used in power or energy systems, including energy asset management systems, power distribution systems, or EV charging management systems. Machine learning systems may be used to estimate data associated with one or more assets, for example telematics data associated with one or more EVs. Machine learning models may be used, as a mere example, to predict future resource availability, demand requirements, EV owner behaviour, and/or control assets in a system, for instance using one or more optimizations. Predictions may be used to control or schedule charging interactions, to schedule EV charging, energy generation, power distribution, energy storage, and/or pricing to optimally coordinate these energy systems to achieve various objectives such as cost minimization, efficiency maximization, or optimal use of local renewable energy. Further, predictors and/or optimizers, and the training thereof, may also use or be based on machine learning techniques.

A machine learning algorithm or system may receive data, for example historical data, streaming controllable asset data, environmental data, and/or third party data, and, using one or more suitable machine learning algorithms, may generate one or more datasets. Example types of machine learning algorithms include but are not limited to supervised learning algorithms, unsupervised learning algorithms, reinforcement learning algorithms, semi-supervised learning algorithms (e.g. where both labeled and unlabeled data is used), regression algorithms (for example logistic regression, linear regression, and so forth), regularization algorithms (for example least-angle regression, ridge regression, and so forth), artificial neural network algorithms, instance based algorithms (for example locally weighted learning, learning vector quantization, and so forth), Bayesian algorithms, decision tree algorithms, clustering algorithms, and so forth. Further, other machine learning algorithms may be used additionally or alternatively. In some embodiments, a machine learning algorithm or system may analyze data to identify patterns and/or sequences of activity, and so forth, to generate one or more datasets.

A system, such as an EV charging control system, may comprise one or more control policies. The control policies of the system may be based on trained machine learning based systems. In this sense, a control policy may be part of a control agent. A control agent observes its environment, herein referred to a control environment, and takes action based on its observations, or percepts, of the control environment. The taking of action is referred to as controlling the system. Depending on the state of the environment, taking action may involve taking no action at all, for example if there has been little or no change in the state since the last time the agent took action. Thus, doing nothing is a valid action in a set of actions in the action space of the controller. In an embodiment, the present systems and methods may exploit the flexibility of controllable assets in the power system to achieve improved performance of the system. For example, the flexibility of controllable assets may be exploited in response to changes in the control environment.

In an embodiment, online machine learning may be employed. Online machine learning is a technique of machine learning where data becomes available sequentially over time. The data is utilized to update a predictor for future data at each step in time (e.g. time slot). This approach of online machine learning may be contrasted to approaches that use batch learning wherein learning performed on an entire or subset of training data set. Online machine learning is sometimes useful where the data varies significantly over time, such as in power or energy pricing, commodity pricing, and stock markets. Further, online machine learning may be helpful when it is not practical or possible to train the agent over the entire or subset of data set.

In embodiments according to the present disclosure, training of a machine learning system, such as an estimator or optimizer, may be based on offline learning and/or online learning where the streaming real-time data may be combined with at least some data, for example from a database, to train the machine learning system in real-time or near real-time.

The term module used herein may refer to a software module, a hardware module, or a module comprising both software and hardware. Generally, software includes computer executable instructions, and possibly also data, and hardware refers to physical computer hardware.

Embodiments and operations according to the present disclosure may be implemented in digital electronic circuitry, and/or in computer software, firmware, and/or hardware, including structures according to this disclosure and their structural equivalents. Embodiments and operations according to the present disclosure may be implemented as one or more computer programs, for example one or more modules of computer program instructions, stored on or in computer storage media for execution by, or to control the operation of, one or more computer processing devices such as a processor. Operations according to the present disclosure may be implemented as operations performed by one or more processing devices on data stored on one or more computer-readable storage devices or media, and/or received from other sources.

Embodiments described herein relate to charging of EVs. However, the scope of the present disclosure is not intended to be limited to charging of EVs. The teachings according to the present disclosure may be used or applied in or with other types of power use, and in other applications and in other fields.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The embodiments according to the present disclosure are intended to be examples only. Alterations, modifications and variations may be effected to the particular embodiments by those of skill in the art without departing from the scope, which is defined solely by the claims appended hereto.

The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects.

### NOMENCLATURE

EV: Electric Vehicle
OPF: Optimal Power Flow
LDC: Local Distribution Company
SOC: State of Charge (of a battery or electrical vehicle)
AI: Artificial intelligence
ML: Machine Learning
RA: Resource Adapter
DR: Demand Response

1. A system, comprising:
a computer-readable storage medium having executable instructions for providing charging control to a plurality of electric controllable assets which include at least some electric vehicles (EVs); and
one or more computer processors configured to execute the instructions to:
determine, by a power flow analyzer, power flow information of a power grid, the power grid for providing power to the controllable assets for charging, the power flow information including technical constraint information relating to the power grid;
generate, by a charging controller, charging control information for providing charging control to the controllable assets based on the power flow information;
provide the charging control information to at least some of the controllable assets;
provide at least part of the charging control information to the power flow analyzer; and
determine, by the power flow analyzer, new power flow information of the power grid for a subsequent time period based on the at least part of the charging control information.

2. The system according to claim 1, wherein the one or more computer processors are further configured to execute the instructions to:
generate, by the charging controller, new charging control information associated with the subsequent time period based on the new power flow information.

3. The system according to claim 1, wherein the determining the power flow information of the power grid by the power flow analyzer is based on topology information and electrical measurement information of the power grid.

4. The system according to claim 1, wherein the one or more computer processors are further configured to execute the instructions to:
generate, by a demand-response recommender, recommended load curtailment information, the recommended load curtailment information including details for load curtailment in the power grid,
wherein at least one of:
the recommended load curtailment information is provided to the charging controller, and wherein the generating charging control information is based on the recommended load curtailment information; and
wherein the recommended load curtailment information is provided an operator of the power grid.

5. The system according to claim 4,
wherein the recommended load curtailment information is provided to the power flow analyzer, and wherein the determining new power flow information of the power grid for the subsequent time period is based on the recommended load curtailment information; and
wherein the generating, by the charging controller, of the new charging control information associated with the subsequent time period is based on the new power flow information.

6. The system according to claim 1, wherein the generating charging control information is further based on predicted load information of the power grid, wherein the predicted load information includes a predicted electric load in a section of the power grid in a future time period.

7. The system according to claim 1, wherein the technical constraint information of the power grid comprises operational limit information of one or more distribution transformers in the power grid.

8. The system according to claim 1, wherein the generating charging control information is based at least in part on an optimization for minimizing violations of the technical constraint information in the power grid.

9. A method comprising:
at one or more electronic devices each having one or more processors and computer-readable memory, for providing charging control to a plurality of electric controllable assets which include at least some electric vehicles (EVs):
determining, by a power flow analyzer, power flow information of a power grid, the power grid for providing power to the controllable assets for charging, the power flow information including technical constraint information relating to the power grid;
generating, by a charging controller, charging control information for providing charging control to the controllable assets based on the power flow information;
providing the charging control information to at least some of the controllable assets;
providing at least part of the charging control information to the power flow analyzer; and
determining, by the power flow analyzer, new power flow information of the power grid for a subsequent time period based on the at least part of the charging control information.

10. The method according to claim 9, further comprising:
generating, by the charging controller, new charging control information associated with the subsequent time period based on the new power flow information.

11. The method according to any one of claims 9 to 10, wherein the determining the power flow information of the power grid by the power flow analyzer is based on topology information and electrical measurement information of the power grid.

12. The method according to claim 9, further comprising:
generating, by a demand-response recommender, recommended load curtailment information, the recommended load curtailment information including details for load curtailment in the power grid,
wherein at least one of:
the recommended load curtailment information is provided to the charging controller, and wherein the generating charging control information is based on the recommended load curtailment information; and
wherein the recommended load curtailment information is provided an operator of the power grid.

13. The method according to claim 12,
wherein the recommended load curtailment information is provided to the power flow analyzer, and wherein the determining new power flow information of the power grid for the subsequent time period is based on the recommended load curtailment information; and
wherein the generating, by the charging controller, of the new charging control information associated with the subsequent time period is based on the new power flow information.

14. The method according to claim 9, wherein the generating charging control information is further based on predicted load information of the power grid, wherein the predicted load information includes a predicted electric load in a section of the power grid in a future time period.

15. The method according to claim 9, wherein the technical constraint information of the power grid comprises operational limit information of one or more distribution transformers in the power grid.

16. The method according to claim 9, wherein the generating charging control information is based at least in part on an optimization for minimizing violations of the technical constraint information in the power grid.

17. A non-transitory computer-readable medium comprising:
computer-readable instructions stored on the computer-readable medium, the instructions for providing charging control to a plurality of electric controllable assets which include at least some electric vehicles (EVs), the computer-readable instructions executable by at least one processor to cause the performance of operations comprising:
determining, by a power flow analyzer, power flow information of a power grid, the power grid for providing power to the controllable assets for charging, the power flow information including technical constraint information relating to the power grid;
generating, by a charging controller, charging control information for providing charging control to the controllable assets based on the power flow information;
providing the charging control information to at least some of the controllable assets;
providing at least part of the charging control information to the power flow analyzer; and
determining, by the power flow analyzer, new power flow information of the power grid for a subsequent time period based on the at least part of the charging control information.

18. The non-transitory computer-readable medium of claim 17, wherein the instructions further cause operations comprising:
generating, by the charging controller, new charging control information associated with the subsequent time period based on the new power flow information.

19. The non-transitory computer-readable medium of claim 17, wherein the technical constraint information of the power grid comprises operational limit information of one or more distribution transformers in the power grid.

20. The non-transitory computer-readable medium of claim 17, wherein the generating charging control information is based at least in part on an optimization for minimizing violations of the technical constraint information in the power grid.
